(19) United States
(12) Patent Application Publication
(10) Pub. No.: US 2023/0244996 A1
(43) Pub. Date: Aug. 3, 2023

(54) AUTO ADAPTING DEEP LEARNING MODELS ON EDGE DEVICES FOR AUDIO AND VIDEO

(71) Applicant: Johnson Controls Tyco IP Holdings LLP, Milwaukee, WI (US)

(72) Inventors: Premanand Kumar, Toronto (CA); Gregory Andrew Makowski, Los Altos, CA (US); Sastry KM Malladi, Fremont, CA (US)

(21) Appl. No.: 18/103,297

(22) Filed: Jan. 30, 2023

Related U.S. Application Data
(60) Provisional application No. 63/267,386, filed on Jan. 31, 2022.

(51) Int. Cl. G06N 20/00

(52) U.S. Cl. CPC G06N 20/00

(57) ABSTRACT

A set of processes enable supervised learning of a machine learning model without human intervention by producing the positive and negative examples at-will in a deployed environment. A technique implements a series of events that replaces the need for human intervention to generate labeled data for supervised learning. This enables automatic retraining of the model in a deployed environment without the need for human labeled data, supporting audio and video data.

### CROSS-REFERENCE TO RELATED PATENT APPLICATIONS

This application claims the benefit of and priority to U.S. Provisional Patent Application No. 63/267,386 filed Jan. 31, 2022, the entirety of which is incorporated by reference herein. The following are incorporated by reference along with all other references cited in this application: U.S. patent application Ser. No. 15/250,720, filed Aug. 29, 2016, issued as U.S. Pat. No. 10,007,513 on Jun. 26, 2018, which claims the benefit of U.S. patent application 62/210,981, filed Aug. 27, 2015; U.S. patent applications 62/312,106, 62/312,187, 62/312,223, and 62/312,255, filed Mar. 23, 2016; U.S. patent application Ser. No. 15/467,306, filed Mar. 23, 2017, issued as U.S. Pat. No. 10,572,230 on Feb. 25, 2020; U.S. patent application Ser. No. 15/467,313, filed Mar. 23, 2017, issued as U.S. Pat. No. 10,564,941 on Feb. 18, 2020; U.S. patent application Ser. No. 15/467,318, filed Mar. 23, 2017, issued as U.S. Pat. No. 10,127,022 on Nov. 13, 2018; and U.S. patent application Ser. No. 16/379,700, filed Apr. 9, 2019.

### BACKGROUND

The invention relates to the field of computing, and more specifically to edge computing to handle the large amounts of data generated by industrial machines.

Traditional enterprise software application hosting has relied on datacenter or “cloud” infrastructure to exploit economies of scale and system efficiencies. However, these datacenters can be arbitrarily distant from the points of physical operations (e.g., factories, warehouses, retail stores, and others), where the enterprise conducts most of its business operations. The industrial Internet of things (IIoT) refers to a collection of devices or use-cases that relies on instrumentation of the physical operations with sensors that track events with very high frequency.

Industrial machines in many sectors com under this Internet of things (IoT) including manufacturing, oil and gas, mining, transportation, power and water, renewable energy, heath care, retail, smart buildings, smart cities, and connected vehicles. Despite the success of cloud computing, there are number of shortcomings: It is not practical to send all of that data to cloud storage because connectivity may not always be there, bandwidth is not enough, or it is cost prohibitive even if bandwidth exists. Even if connectivity, bandwidth, and cost are not issues, there is no real-time decision making and predictive maintenance that can result in significant damage to the machines.

Therefore, improved computing systems, architectures, and techniques including improved edge analytics are needed to handle the large amounts of data generated by industrial machines, especially for acoustic detection and retraining.

### SUMMARY OF THE INVENTION

A set of processes enable supervised learning of a machine learning model without human intervention, or with minimal intervention, by producing the positive and negative signals at-will in a deployed environment. A technique implements a series of events that replaces the need for human intervention to generate labeled data for supervised learning. This enables automatic retraining of the model in a deployed environment without the need for human labeled data. The process supports a variety of sensor or media types, including but not limited to: audio, video & image, infra-red, other frequency ranges and distance sensors. The sensors are not limited by human hearing or visual ranges. Vibration or audio could be at much lower or higher frequencies. Light or other spectrums can also be outside of the range of human sight, above or below, such as for infra-red, spectrometer or X-ray wavelengths.

One implementation of the present disclosure is a method for automatically detecting events. The method includes receiving a signal from an audio or visual device in a deployed environment, running a preprocessing script for buffering the signal to a particular length to feed into a machine learning model, running the signal into the machine learning model to identify one or more negative examples, mixing the negative examples with a saved pure example to create one or more positive examples, and using the created one or more positive examples and one or more negative examples to retrain the machine learning model at an edge device without the need for human annotation.

In some implementations, the method for running the signal into the machine learning model to identify negative examples in scripts or models, or both, the model containing an inference script which calls the model at initialization. This script takes care of preprocessing, such as the spectrogram extraction from the sound signal and provides a labeled positive and negative output. This script saves the negative example in the edge. In some implementations, the method for mixing the negative examples with the saved pure example to create positive examples comprises a trigger event that precedes retraining. This script is among the bundled scripts discussed above and provides for a mixture of pure audio signals (for example) stored in the edge with the negative examples from the environment to create positive examples. The positive examples are then stored in the edge. The method for using the created positive and negative sample to retrain the model at the edge device without the need for human annotation where a trigger event calls for re-training the model that is stored in an edge machine learning (e.g., EdgeML). This script is among the bundled scripts. The model is trained on the created positive example and saved negative examples. Once retrained, it bundles up the model to create new a new EdgeML and replaces the current version of EdgeML.

In various implementations, the audio or visual device includes at least one of a microphone, a video device, and an infra-red or distance sensor. In some implementations, the method further includes bundling the machine learning model with scripts for at least one of an inference event, a training event, a pure audio event, a video event, and an infra-red or distance sensor event. In some implementations, running the signal into the machine learning model to identify negative examples includes calling, by at least one of the inference scripts, the machine learning model at initialization, extracting a spectrogram from the sound signal, and providing a labeled positive and negative output or saving the negative example on the edge device.

In some implementations, mixing the negative examples with the saved pure example to create positive examples includes receiving a trigger event that precedes retraining the machine learning model, mixing the pure examples of supported types stored in the edge device with the negative examples from the environment to create positive examples, and storing the positive examples in the edge device.

In some implementations, the method further includes calling, based on a trigger event, for re-training the machine learning model that is stored in the edge device, re-training the machine learning model on the created positive example and saved negative examples, bundling up the machine learning model to create a new edge machine learning version, and replacing the current version of edge machine learning with the new edge machine learning version. In some implementations, further includes optimizing at least one of a software component or a hardware component executing the machine learning model.

In various implementations, a method bundles machine learning models with scripts for at least one of inference, training, or pure audio, video or other types of events, or any combination. These models and scripts enable the method described above.

One implementation of the present disclosure is a method for automatically detecting a trigger event for re-training a machine learning model. The method includes receiving a distribution of training data, creating a distribution of current data based on the distribution of training data, compare the difference between the distribution of training data and the distribution of current data, and in response to the difference being above a first threshold, detect a trigger event for re-training the machine learning model.

In some implementations, comparing the differences between the distribution of training data and the distribution of current data comprises measuring the Kullback-Leibler divergence between the distribution of training data and the distribution of current data. In some implementations, comparing the differences between the distribution of training data and the distribution of current data comprises measuring the difference in accuracy between the distribution of training data and the distribution of current data. In some implementations, the method further includes re-training the machine learning model using close loop learning in response to detecting the trigger event.

Yet another implementation of the present disclosure is a system. The system includes an audio or visual device and a computing system. The computing system includes one or more processors and a memory. The memory has instructions stored thereon that, when executed by the one or more processors, cause the one or more processors to receive a signal from an audio or visual device in a deployed environment, run a preprocessing script for buffering the signal to a particular length to feed into a machine learning model, run the signal into the machine learning model to identify one or more negative examples, mix the negative examples with a saved pure example to create one or more positive examples, and use the created one or more positive examples and one or more negative examples to retrain the machine learning model at an edge device without the need for human annotation.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows a block diagram of a client-server system and network.

FIG. 2 shows a more detailed diagram of a client or server.

FIG. 3 shows a system block diagram of a computer system.

FIG. 4 a block diagram of an edge computing platform, which is between sensor streams and the cloud.

FIG. 5 shows a more detailed block diagram of an edge computing platform including edge analytics.

FIG. 6 shows an operational flow between edge infrastructure and cloud infrastructure.

FIG. 7 shows an example of using physical sensors to create, via a sensor expression language engine, some virtual sensors.

FIG. 8 shows a system for supervised learning.

FIG. 9 shows another system for supervised learning, which can automatically generate positive and negative signals block with an Augmenter. This is expanded in FIG. 10.

FIG. 10 shows more details of an implementation of an automatic retraining of audio/video deep learning models on edge devices after deployment (FIG. 9 expanded).

FIGS. 11A (audio) and 11V (video and other) show a technique of initial off-line model training (an expansion of FIG. 10, block 500).

FIG. 11J shows Jaccard Index or intersection over union (IOU) (expansion of FIG. 11V, block 1149, “model training”).

FIG. 11MO shows model optimization (expansion of FIG. 11A, block 1124 or FIG. 11V, block 1155).

FIG. 12 shows an EdgeML model (expanded FIG. 10, block 503).

FIG. 12F shows using a fast fourier transform (FFT) algorithm to create a spectrogram (expanded FIG. 12, block 1214).

FIG. 12C shows a closed loop learning (CLL) and its triggers (expanded FIG. 10, block 524).

FIG. 12K1 shows using KL-divergence to detect change and start closed loop learning (CLL) (expanded FIG. 12c, block 1250).

FIG. 13 shows a diagram for the App Trainer (expanded FIG. 10 block 559).

FIG. 14 shows the diagram for the Augmenter (expanded from FIG. 9 block 923 and FIG. 13, block 1309) expanded.

FIG. 15A shows a spectrogram for a pure audio signal for a cough.

FIG. 15B shows a spectrogram for a background sound.

FIG. 15C shows a spectrogram resulting from the software Augmenter. In this case, it is a sound mixer to simulate the cough in a local background.

FIG. 15D shows a spectrogram for a positive event (e.g., a cough) actually happening in an environment.

FIGS. 15E to 15G are specific to image and video support, in contrast to FIGS. 15A to 15D which were for audio support. FIG. 15E provides visual subjects of interest, which are the positive examples. In this case, people without hard hats, a safety alert condition.

FIG. 15F shows a visual local background, which may include confusion cases to be learned.

FIG. 15G shows the combined visual subjects of interest on the local background.

### DETAILED DESCRIPTION

FIG. 1 is a simplified block diagram of a distributed computer network 100 incorporating an embodiment of the present invention. Computer network 100 includes a number of client systems 113, 116, and 119, and a server system 122 coupled to a communication network 124 via a plurality of communication links 128. Communication network 124 provides a mechanism for allowing the various components of distributed network 100 to communicate and exchange information with each other.

Communication network 124 may itself be comprised of many interconnected computer systems and communication links. Communication links 128 may be hardwire links, optical links, satellite or other wireless communications links, wave propagation links, or any other mechanisms for communication of information. Communication links 128 may be DSL, Cable, Ethernet or other hardwire links, passive or active optical links, 3G, 3.5G, 4G and other mobility, satellite or other wireless communications links, wave propagation links, or any other mechanisms for communication of information.

Various communication protocols may be used to facilitate communication between the various systems shown in FIG. 1. These communication protocols may include VLAN, MPLS, TCP/IP, Tunneling, HTTP protocols, wireless application protocol (WAP), vendor-specific protocols, customized protocols, and others. While in one embodiment, communication network 124 is the Internet, in other embodiments, communication network 124 may be any suitable communication network including a local area network (LAN), a wide area network (WAN), a wireless network, an intranet, a private network, a public network, a switched network, and combinations of these, and the like.

Distributed computer network 100 in FIG. 1 is merely illustrative of an embodiment incorporating the present invention and does not limit the scope of the invention as recited in the claims. One of ordinary skill in the art would recognize other variations, modifications, and alternatives. For example, more than one server system 122 may be connected to communication network 124. As another example, a number of client systems 113, 116, and 119 may be coupled to communication network 124 via an access provider (not shown) or via some other server system.

Client systems 113, 116, and 119 typically request information from a server system which provides the information. For this reason, server systems typically have more computing and storage capacity than client systems. However, a particular computer system may act as both as a client or a server depending on whether the computer system is requesting or providing information. Additionally, although aspects of the invention have been described using a client-server environment, it should be apparent that the invention may also be embodied in a stand-alone computer system.

Server 122 is responsible for receiving information requests from client systems 113, 116, and 119, performing processing required to satisfy the requests, and for forwarding the results corresponding to the requests back to the requesting client system. The processing required to satisfy the request may be performed by server system 122 or may alternatively be delegated to other servers connected to communication network 124.

Client systems 113, 116, and 119 enable users to access and query information stored by server system 122. In a specific embodiment, the client systems can run as a standalone application such as a desktop application or mobile smartphone or tablet application. In another embodiment, a “web browser” application executing on a client system enables users to select, access, retrieve, or query information stored by server system 122. Examples of web browsers include the Internet Explorer browser program provided by Microsoft Corporation, Firefox browser provided by Mozilla, Chrome browser provided by Google, Safari browser provided by Apple, and others.

In a client-server environment, some resources (e.g., files, music, video, or data) are stored at the client while others are stored or delivered from elsewhere in the network, such as a server, and accessible via the network (e.g., the Internet). Therefore, the user's data can be stored in the network or “cloud.” For example, the user can work on documents on a client device that are stored remotely on the cloud (e.g., server). Data on the client device can be synchronized with the cloud.

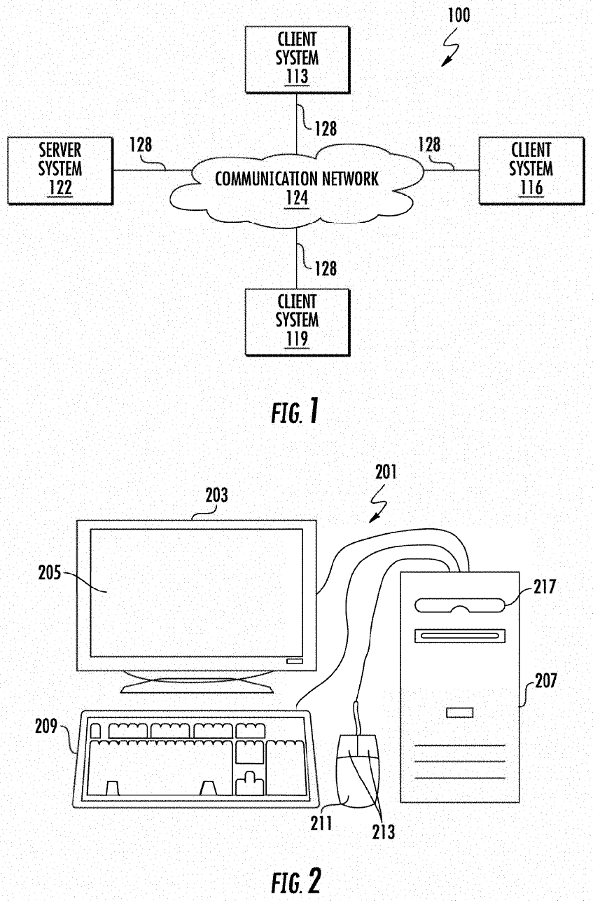

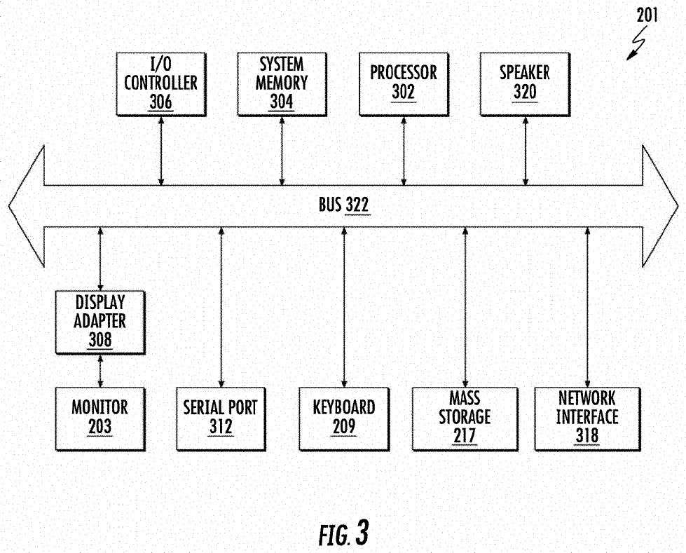

FIG. 2 shows an exemplary client or server system of the present invention. In an embodiment, a user interfaces with the system through a computer workstation system, such as shown in FIG. 2. FIG. 2 shows a computer system 201 that includes a monitor 203, screen 205, enclosure 207 (may also be referred to as a system unit, cabinet, or case), keyboard or other human input device 209, and mouse or another pointing device 211. Mouse 211 may have one or more buttons such as mouse buttons 213.

It should be understood that the present invention is not limited any computing device in a specific form factor (e.g., desktop computer form factor), but can include all types of computing devices in various form factors. A user can interface with any computing device, including smartphones, personal computers, laptops, electronic tablet devices, global positioning system (GPS) receivers, portable media players, personal digital assistants (PDAs), other network access devices, and other processing devices capable of receiving or transmitting data.

For example, in a specific implementation, the client device can be a smartphone or tablet device, such as the Apple iPhone (e.g., Apple iPhone 13 and iPhone 13 Pro), Apple iPad (e.g., Apple iPad or Apple iPad mini), Apple iPod (e.g., Apple iPod Touch), Samsung Galaxy product (e.g., Galaxy S series product or Galaxy Note series product), Google Nexus, Google Pixel devices (e.g., Google Pixel 5), and Microsoft devices (e.g., Microsoft Surface tablet). Typically, a smartphone includes a telephony portion (and associated radios) and a computer portion, which are accessible via a touch screen display.

There is nonvolatile memory to store data of the telephone portion (e.g., contacts and phone numbers) and the computer portion (e.g., application programs including a browser, pictures, games, videos, and music). The smartphone typically includes a camera (e.g., front facing camera or rear camera, or both) for taking pictures and video. For example, a smartphone or tablet can be used to take live video that can be streamed to one or more other devices.

Enclosure 207 houses familiar computer components, some of which are not shown, such as a processor, memory, mass storage devices 217, and the like. Mass storage devices 217 may include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, RD-DVD, or Blu-ray Disc), flash and other nonvolatile solid-state storage (e.g., USB flash drive or solid-state drive (SSD)), battery-backed-up volatile memory, tape storage, reader, and other similar media, and combinations of these.

A computer-implemented or computer-executable version or computer program product of the invention may be embodied using, stored on, or associated with computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software of the present invention may be stored or reside in RAM or cache memory, or on mass storage device 217. The source code of the software of the present invention may also be stored or reside on mass storage device 217 (e.g., hard disk, magnetic disk, tape, or CD-ROM). As a further example, code of the invention may be transmitted via wires, radio waves, or through a network such as the Internet.

FIG. 3 shows a system block diagram of computer system 201 used to execute the software of the present invention. As in FIG. 2, computer system 201 includes monitor 203, keyboard 209, and mass storage devices 217. Computer system 501 further includes subsystems such as central processor 302, system memory 304, input/output (I/O) controller 306, display adapter 308, serial or universal serial bus (USB) port 312, network interface 318, and speaker 320. The invention may also be used with computer systems with additional or fewer subsystems. For example, a computer system could include more than one processor 302 (e.g., a multiprocessor system) or a system may include a cache memory.

Arrows such as 322 represent the system bus architecture of computer system 201. However, these arrows are illustrative of any interconnection scheme serving to link the subsystems. For example, speaker 320 could be connected to the other subsystems through a port or have an internal direct connection to central processor 302. The processor may include multiple processors or a multicore processor, which may permit parallel processing of information. Computer system 201 shown in FIG. 2 is but an example of a computer system suitable for use with the present invention. Other configurations of subsystems suitable for use with the present invention will be readily apparent to one of ordinary skill in the art.

Computer software products may be written in any of various suitable programming languages, such as C, C++, C#, Pascal, Fortran, Perl, MATLAB (from MathWorks), SAS, SPSS, JavaScript, AJAX, Java, Python, Erlang, R and Ruby on Rails. The computer software product may be an independent application with data input and data display modules. Alternatively, the computer software products may be classes that may be instantiated as distributed objects. The computer software products may also be component software such as Java Beans (from Oracle Corporation) or Enterprise Java Beans (EJB from Oracle Corporation).

An operating system for the system may be one of the Microsoft Windows® family of systems (e.g., Windows 95, 98, Me, Windows NT, Windows 2000, Windows XP, Windows Vista, Windows 7, Windows 8, Windows 10, Windows 11, Windows CE, Windows Mobile, Windows RT), Symbian OS, Tizen, Linux, HP-UX, UNIX, Sun OS, Solaris, Mac OS X, Apple iOS, Android, Alpha OS, AIX, IRIX32, or IRIX64. Other operating systems may be used. Microsoft Windows is a trademark of Microsoft Corporation.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (e.g., IEEE standards 802.11, 802.11a, 802.11b, 802.11e, 802.11g, 802.11i, 802.11n, 802.11ac (e.g., Wi-Fi 5), 802.11ad, 802.11ax (e.g., Wi-Fi 6), and 802.11af, just to name a few examples), near field communication (NFC), radio-frequency identification (RFID), mobile or cellular wireless (e.g., 2G, 3G, 4G, 5G, 3GPP LTE, WiMAX, LTE, LTE Advanced, Flash-OFDM, HIPERMAN, iBurst, EDGE Evolution, UMTS, UMTS-TDD, 1×RDD, and EV-DO). For example, signals from a computer may be transferred, at least in part, wirelessly to components or other computers.

In an embodiment, with a web browser executing on a computer workstation system, a user accesses a system on the World Wide Web (WWW) through a network such as the Internet. The web browser is used to download web pages or other content in various formats including HTML, XML, text, PDF, and postscript, and may be used to upload information to other parts of the system. The web browser may use uniform resource identifiers (URLs) to identify resources on the web and hypertext transfer protocol (HTTP) in transferring files on the web.

In other implementations, the user accesses the system through either or both of native and nonnative applications. Native applications are locally installed on the particular computing system and are specific to the operating system or one or more hardware devices of that computing system, or a combination of these. These applications (which are sometimes also referred to as “apps”) can be updated (e.g., periodically) via a direct internet upgrade patching mechanism or through an applications store (e.g., Apple iTunes and App store, Google Play store, Windows Phone store, and Blackberry App World store).

The system can run in platform-independent, nonnative applications. For example, client can access the system through a web application from one or more servers using a network connection with the server or servers and load the web application in a web browser. For example, a web application can be downloaded from an application server over the Internet by a web browser. Nonnative applications can also be obtained from other sources, such as a disk.

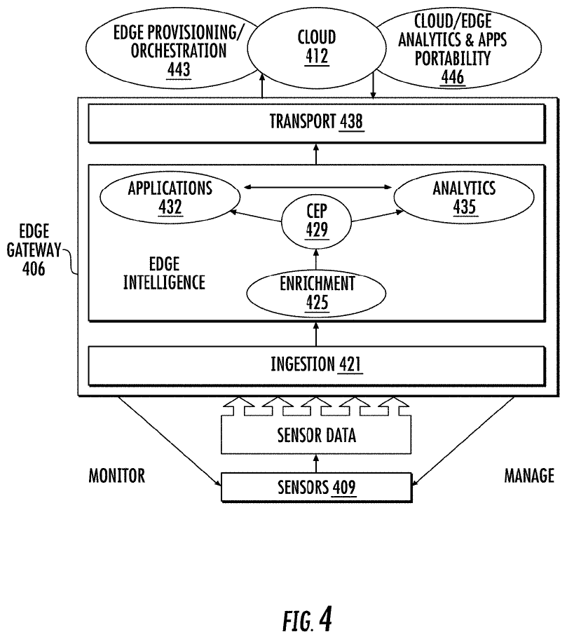

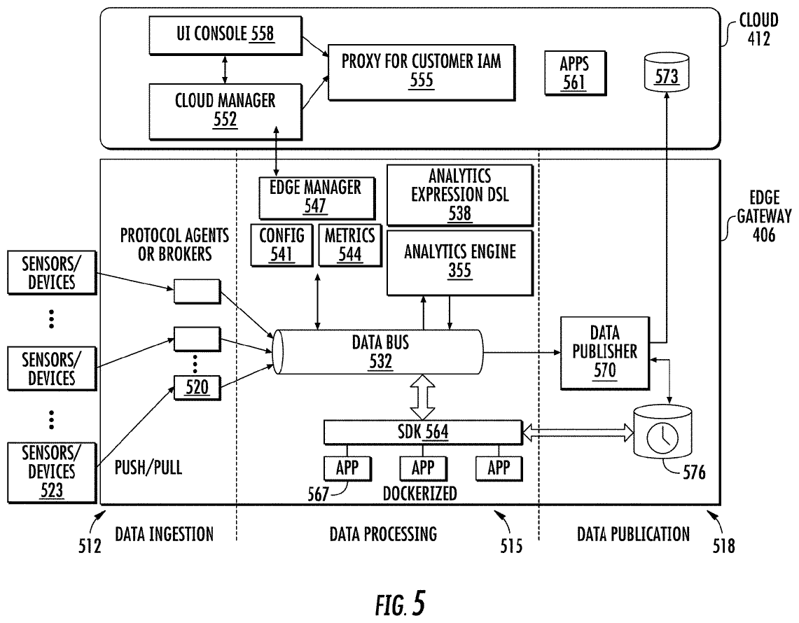

FIG. 4 shows a block diagram of an edge computing platform 406 typically running on an edge gateway or equivalent that is between sensors 409 and cloud 412. The edge computing platform enables deriving edge intelligence that is important for managing and optimizing industrial machines and other industrial Internet of things. Components of the edge gateway include the following: ingestion 421, enrichment 425, complex event processing (CEP) engine 429, applications 432, analytics through an expression language 435, and transport 438. The cloud can include edge provisioning and orchestration 443 and cloud and edge analytics and apps portability 446.

As discussed above, a specific implementation of an edge computing platform is from FogHorn. FogHorn is a leader in the rapidly emerging domain of “edge intelligence.” By hosting high performance processing, analytics, and heterogeneous applications closer to control systems and physical sensors, FogHorn's breakthrough solution enables edge intelligence for closed loop device optimization. This brings big data and real-time processing onsite for industrial customers in manufacturing, oil and gas, power and water, transportation, mining, renewable energy, smart city, and more. FogHorn technology is embraced by the world's leading industrial Internet innovators and major players in cloud computing, high performance edge gateways, and IoT systems integration.

FogHorn provides: Enriched IoT device and sensor data access for edge apps in both stream and batch modes. Highly efficient and expressive DSL for executing analytical functions. Powerful miniaturized analytics engine that can run on low footprint machines. Publishing function for sending aggregated data to cloud for further machine learning. SDK (polyglot) for developing edge apps. Management console for managing edge deployment of configurations, apps, and analytics expressions.

FogHorn provides an efficient and highly scalable edge analytics platform that enables real-time, on-site stream processing of sensor data from industrial machines. The FogHorn software stack is a combination of services that run on the edge and cloud.

An “edge” solution may support ingesting of sensor data into a local storage repository with the option to publish the unprocessed data to a cloud environment for offline analysis. However, many industrial environments and devices lack Internet connectivity making this data unusable. But even with Internet connectivity, the sheer amount of data generated could easily exceed available bandwidth or be to cost prohibitive to send to the cloud. In addition, by the time data is uploaded to the cloud, processed in the data center, and the results transferred back to the edge, it may be too late to take any action.

The FogHorn solution addresses this problem by providing a highly miniaturized complex event processing (CEP) engine, also known as an analytics engine, and a powerful and expressive domain specific language (DSL) to express rules on the multitude of the incoming sensor streams of data. Output from these expressions can then be used immediately to prevent costly machine failures or downtime as well as improve the efficiency and safety of industrial operations and processes in real time.

The FogHorn platform includes: Ability to run in low footprint environments as well as high throughput or gateway environments. Highly scalable and performant CEP engine that can act on incoming streaming sensor data. Heterogeneous app development and deployment on the edge with enriched data access. Application mobility across the cloud and edge. Advanced machine learning (ML) and model transfer between cloud and edge. Out of the box, FogHorn supports the major industrial data ingestion protocols (e.g., OPC-UA, Modbus, MQTT, DDS, and others) as well as other data transfer protocols. In addition, users can easily plug-in custom protocol adaptors into FogHorn's data ingestion layer.

FogHorn edge services operate at the edge of the network where the IIoT devices reside. The edge software stack is responsible for ingesting the data from sensors and industrial devices onto a high-speed data bus and then executing user-defined analytics expressions on the streaming data to gain insights and optimize the devices. These analytical expressions are executed by FogHorn's highly scalable and small footprint complex event processing (CEP) engine.

FogHorn edge services also include a local time-series database for time-based sensor data queries and a polyglot SDK for developing applications that can consume the data both in stream and batch modes. Optionally, this data can also be published to a cloud storage destination of the customer's choice.

The FogHorn platform also includes services that run in the cloud or on-premises environment to remotely configure and manage the edges. FogHorn's cloud services include a management UI for developing and deploying analytics expressions, deploying applications to the edge using an application known as Docker (www.docker.com), and for managing the integration of services with the customer's identity access management and persistence solutions. The platform will also be able to translate machine learning models developed in the cloud into sensor expressions that can be executed at the edge.

FogHorn brings a groundbreaking dimension to the industrial Internet of things by embedding edge intelligence computing platform directly into small footprint edge devices. The software's extremely low overhead allows it to be embedded into a broad range of edge devices and highly-constrained environments.

Available in Gateway and Micro editions, FogHorn software enables high performance edge processing, optimized analytics, and heterogeneous applications to be hosted as close as possible to the control systems and physical sensor infrastructure that pervade the industrial world. Maintaining close proximity to the edge devices rather than sending all data to a distant centralized cloud, minimizes latency allowing for maximum performance, faster response times, and more effective maintenance and operational strategies. It also significantly reduces overall bandwidth requirements and the cost of managing widely distributed networks.

FogHorn Gateway Edition. The FogHorn Gateway Edition is a comprehensive fog computing software suite for industrial IoT use-cases across a wide range of industries. Designed for medium to large scale environments with multiple Industrial machines or devices, this edition enables user-configurable sensor data ingestion and analytics expressions and supports advanced application development and deployment.

FogHorn Micro Edition. The FogHorn Micro Edition brings the power of fog computing to smaller footprint edge gateways and other IoT machines. The same CEP analytics engine and highly expressive DSL included in the Gateway edition are available in the Micro Edition. This edition is ideal for enabling advanced edge analytics in embedded systems or any memory-constrained devices.

As examples, an application applies real-time data monitoring and analysis, predictive maintenance scheduling, and automated flow redirection to prevent costly damage to pumps due to cavitation events. Another example is wind energy management system using FogHorn edge intelligence software to maximize power generation, extend equipment life, and apply historical analysis for accurate energy forecasting.

FIG. 5 shows a more detailed block diagram of an edge computing platform. This platform has three logical layers or sections, data ingestion 512, data processing 515, and data publication 518. The data ingestion components include agents 520 that are connected to sensors or devices 523 that generate data. The agents collect or ingest data from the sensors via one or more protocols from the respective protocol servers. The agents can be clients or brokers for protocols such as, among others, MQTT, OPC UA, Modbus, and DDS. The data provided or output by the sensors is typically a binary data stream. The transmission or delivery of this data from the sensors to the agents can be by push or pull methods.

Push describes a style of communication where the request for a given transaction is initiated by the sender (e.g., sensor). Pull (or get) describes a style of communication where the request for the transmission of information is initiated by receiver (e.g., agent). Another communication technique is polling, which the receiver or agent periodically inquires or checks the sensor has data to send.

MQTT (previously MQ Telemetry Transport) is an ISO standard publish-subscribe-based “lightweight” messaging protocol for use on top of the TCP/IP protocol. Alternative protocols include the Advanced Message Queuing Protocol, the IETF Constrained Application Protocol, XMPP, and Web Application Messaging Protocol (WAMP).

OPC Unified Architecture (OPC UA) is an industrial M2M communication protocol for interoperability developed by the OPC Foundation. It is the successor to Open Platform Communications (OPC).

Modbus is a serial communications protocol originally published by Modicon (now Schneider Electric) in 1979 for use with its programmable logic controllers (PLCs). Simple and robust, it has since become for all intents and purposes a standard communication protocol. It is now a commonly available means of connecting industrial electronic devices.

Data processing 515 includes a data bus 532, which is connected to the agents 520 of the data ingestion layer. The data bus is the central backbone for both data and control messages between all connected components. Components subscribe to the data and control messages flowing through the data bus. The analytics engine 535 is one such important component. The analytics engine performs analysis of the sensor data based on an analytic expression developed in expression language 538. Other components that connect to the data bus include configuration service 541, metrics service 544, and edge manager 547. The data bus also includes a “decoder service” that enriches the incoming data from the sensors by decoding the raw binary data into consumable data formats (such as JSON) and also decorating with additional necessary and useful metadata. Further, enrichment can include, but is not limited to, data decoding, metadata decoration, data normalization, and the like.

JSON (sometimes referred to as JavaScript Object Notation) is an open-standard format that uses human-readable text to transmit data objects consisting of attribute-value pairs. JSON is a common data format used for asynchronous browser or server communication (AJAJ) or both. An alternative to JSON is XML, which is used by AJAX.

The edge manager connects to cloud 412, and in particular to a cloud manager 552. The cloud manager is connected to a proxy for customer identity and access management (IAM) 555 and user interface console 558, which are also in the cloud. There are also apps 561 accessible via the cloud. Identity and access management is the security and business discipline that enables the right individuals to access the right resources at the right times and for the right reasons.

Within data processing 515, a software development kit (SDK) 564 component also connects to the data bus, which allows the creation of applications 567 that work that can be deployed on the edge gateway. The software development kit also connects to a local time-series database to fetch the data. The applications can be containerized, such as by using a container technology such as Docker.

Docker containers wrap up a piece of software in a complete file system that contains everything it needs to run: code, runtime, system tools, and system libraries—anything that can be installed on a server. This ensures the software will always run the same, regardless of the environment it is running in.

Data publication 518 includes a data publisher 570 that is connected to a storage location 573 in the cloud. Also, applications 567 of the software development kit 564 can access data in a time-series database 576. A time-series database (TSDB) is a software system that is optimized for handling time series data, arrays of numbers indexed by time (e.g., a date-time or a date-time range). The time-series database is typically a rolling or circular buffer or queue, where as new information is added to the database, the oldest information is being removed. A data publisher 570 also connects to the data bus and subscribes to data that needs to be stored either in the local time-series database or in the cloud storage.

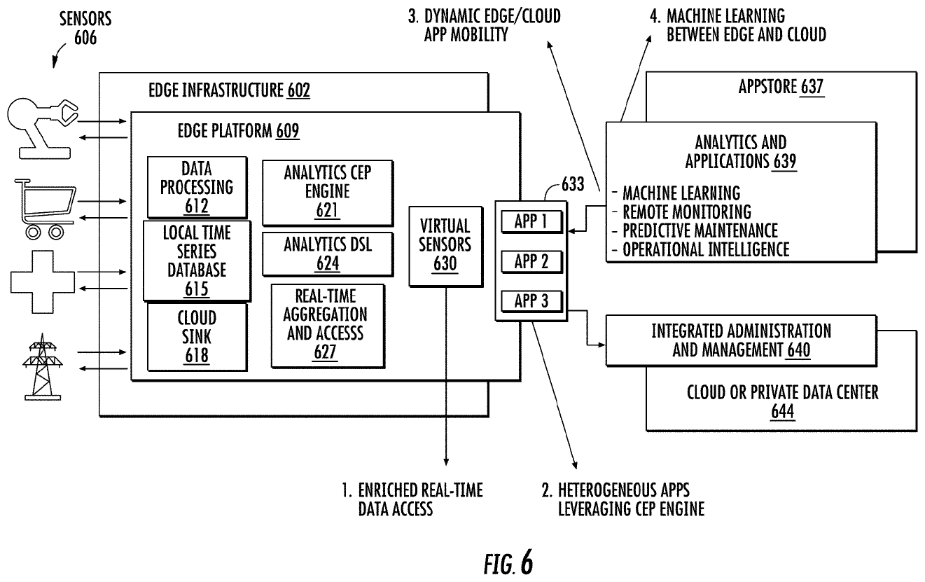

FIG. 6 shows an operational flow between edge 602 and cloud infrastructures. Some specific edge infrastructures were described above. Data is gathered from sensors 606. These sensors can be for industrial, retail, health care, or medical devices, or power or communication applications, or any combination of these.

The edge infrastructure includes a software platform 609, which has data processing 612, local time-series database 615, cloud sink 618, analytics complex event processing engine (CEP) 621, analytics real-time streaming domain-specific language (DSL) 624 (e.g., the Vel (or VEL) language by FogHorn), and real-time aggregation and access 627. The platform can include virtual sensors 630, which are described below in more detail. The virtual sensors provide enriched real-time data access.

The platform is accessible via one or more apps 633, such as apps or applications 1, 2, and 3, which can be developed using a software development kit or SDK. The apps can be heterogeneous (e.g., developed in multiple different languages) and leverage complex event processing engine 621, as well as perform machine learning. The apps can be distributed using an app store 637, which may be provided by the edge platform developer or the customer of the edge platform (which may be referred to as a partner). Through the app store, users can download and share apps with others. The apps can perform analytics and applications 639 including machine learning, remote monitoring, predictive maintenance, or operational intelligence, or any combination of these.

For the apps, there is dynamic app mobility between edge and cloud. For example, applications developed using the FogHorn software development kit can either be deployed on the edge or in the cloud, thereby achieving app mobility between edge and cloud. The apps can be used as part of the edge or as part of the cloud. In an implementation, this feature is made possible due to the apps being containerized, so they can operate independent of the platform from which they are executed. The same can be said of the analytics expressions as well.

There are data apps that allow for integrated administration and management 640, including monitoring or storing of data in the cloud or at a private data center 644.

A physical sensor is an electronic transducer, which measures some characteristics of its environment as analog or digital measurements. Analog measurements are typically converted to digital quantities using analog to digital Converters. Sensor data are either measured on need based (polled) or available as a stream at a uniform rate. Typical sensor specifications are range, accuracy, resolution, drift, stability, and other attributes. Most measurement systems and applications utilize or communicate the sensor data directly for processing, transportation, or storage.

The system has a “programmable software-defined sensor,” also called a virtual sensor, which is a software-based sensor created using an analytics expression language. In an implementation, the analytics expression language is FogHorn's analytics expression language. This expression language is known as Vel and is described in more detail in other patent applications. The Vel language is implemented efficiently to support real-time streaming analytics in a constrained low footprint environment with low latencies of execution. For example, a latency of the system can be about 10 milliseconds or less.

In an implementation, the programmable software-defined sensor is created with a declarative application program interface (API) called a “sensor expression language” or SXL. A specific implementation of an SXL language is Vel from FogHorn. An Vel-sensor is a sensor created through this construct, and provides derived measurements from processing data generated by multiple sources including physical and Vel-sensors. SXL and Vel can be used interchangeably.

A Vel sensor can be derived from any one of or a combination of these three sources:

1. A single sensor data.

1.1. A virtual or Vel sensor derived from a single physical sensor could transform the incoming sensor data using dynamic calibration, signal processing, math expression, data compaction or data analytics, of any combination.

2. Multiple physical sensor data.

2.1. A virtual or Vel sensor or derived as a transformation (using the methods described above) from multiple heterogeneous physical sensors.

3. A combination of physical sensor data and virtual sensor data made available to the implementation of the Vel-sensor apparatus.

Vel sensors are domain-specific and are created with a specific application in mind. A specific implementation of Vel programming interface enables applications to define data analytics through transformations (e.g., math expressions) and aggregations. Vel includes a set of mathematical operators, typically based on a programming language. Vel sensors operate at runtime on data by executing Vel constructs or programs.

Creation of Vel Sensors. Vel sensors are designed as software apparatuses to make data available in real-time. This requires the execution of applications developed with the Vel in real-time on embedded compute hardware to produce the Vel-sensor data at a rate required by the application. The system includes a highly efficient execution engine to accomplish this.

Some benefits of Vel sensors include:

1. Programmability. Vel makes Vel sensors programmable to synthesize data to match specific application requirements around data quality, frequency, and information. Vel-sensors can be widely distributed as over-the-air software upgrades to plug into data sourced from physical sensors and other (e.g., preexisting) Vel sensors. Thus, application developers can create a digital infrastructure conducive to the efficient execution of business logic independent of the layout of the physical infrastructure.

2. Maintainability or Transparency. Vel-sensors create a digital layer of abstraction between applications and physical sensors, which insulates developers from changes in the physical infrastructure due to upgrades and services to the physical sensors.

3. Efficiency: Vel-sensors create efficiencies in information management by transforming raw data from physical sensors into a precise representation of information contained in them. This efficiency translates into efficient utilization of IT resources like compute, networking, and storage downstream in the applications.

4. Real-time data: Vel-sensors provide real-time sensor data that is computed from real-world or physical sensor data streams. This makes the data available for applications with minimum time delays.

Implementation. The system has architected a scalable, real-time implementation of Vel-sensors based on a Vel interface. Vel includes operators supported by Java language and is well integrated with physical sensors and their protocols.

The system brings a novel methodology for precisely expressing the operations on physical sensors' data to be executed. This declarative expression separates the definition of the digital abstraction from the implementation on the physical sensors.

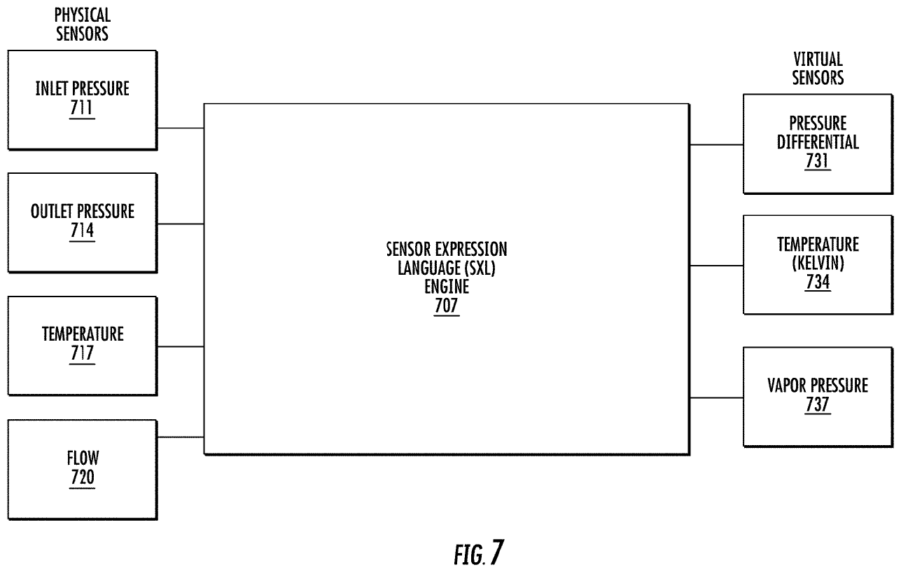

FIG. 7 shows sensor expression language engine 707 that is used to create virtual sensors from inputs. The sensor expression language engine takes input from physical sensors or other virtual sensors. Some examples of inputs include inlet pressure 711, outlet pressure 714, temperature 717, and flow 720. Any number of inputs or combination of inputs can be used as input to a virtual sensor. Based on the input, the sensor expression language engine can generate a virtual sensor with outputs, such as pressure differential 731, temperature 734 (which may be in Kelvin), and vapor pressure 737. There can be any number of virtual sensors and outputs. As described, the output can be a mathematical function of the inputs to the virtual sensor.

Although FIG. 7 shows a box (e.g., 731, 734, and 737) that is representative of a virtual sensor. A virtual sensor can have multiple outputs. For example, virtual sensors 731 and 734 can be combined into a single virtual sensor having two outputs. Virtual sensors 731, 734, and 737 can be combined into a single virtual sensor having three outputs.

Automatic retraining of acoustic deep learning models on edge devices after deployment. Edge devices which connect to millions of people will have a wide varied environment at different points of time. Hence, the machine learning model has to adapt to the varied local environment for detection.

The Machine Learning model suffers from the problem of generalization unless the data in which it is trained on is vast. Even then, it suffers from the loss of accuracy by not taking advantage of a non-changing cyclic environment once the model is deployed. The local environment may have new “confusion cases,” similar to what needs to be detected, but should not be detected. One way to get around the problem is to retrain the model once it is deployed to make up for the unseen scenarios or new confusion cases. The unseen scenarios are usually varied background lighting in case of object detection or in the case of audio, a persistent background noise based on varying activity throughout the day. For audio data, the example of detecting a cough would be useful relating to COVID applications. For audio data, detecting a “cough” could be confused with a guttural language sound that may occur in deployment in other areas of the world where the language may have more guttural sounds. For visual data, if a target of object recognition is a “helmet,” it is possible that some types of hats or a bald head could be a confusion case. For detecting safety goggles (without elastic straps or side splash shields) visually similar confusion cases includes large lens glasses or sunglasses. However, the retraining requires human-hours for the data to be labeled again. To add to that, if the event is rare, it becomes practically impossible to comb for that event in a real time deployment. The proposed solution has the ability to create its own event for classification and mixes it with the deployed environment. It provides the opportunity for the model to conduct experiments on the accuracy and if needed, retrain the model with the same dataset used for experimentation.

The invention here is the set of processes that will enable supervised learning of the Machine learning model without human intervention by producing the positive and negative examples at-will in the deployed environment.

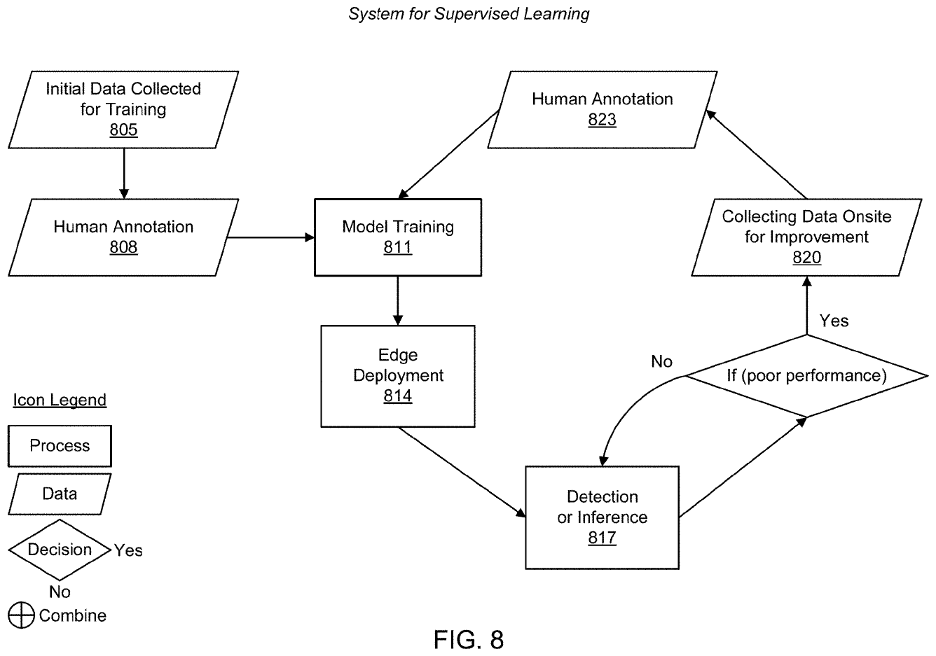

FIG. 8 shows a system for supervised learning. The system includes initial data collected for training (through staging, internet, test site locations or three-dimensional image generation) (805). The initial data collected for training outputs to human annotation (808) where a human may evaluate the data and categorize and label the data to be used by the machine learning model. The annotated data may output to model training (811) where the machine learning model is trained with the annotated data. Model training output to edge deployment (814) where the model is used to detect an event (e.g., inference event, a training event, a pure audio event, a video event, and an infra-red or distance sensor event, etc.) at detection (817), which outputs to collecting data on site for improvement (820). Typically, between detection 817 and collecting data 820, there is possible poor performance. Collecting data 820 output to human annotation (823) where the additional data collected onsite at 820 is further annotated by a human in order to improve the performance of the machine learning model 811.

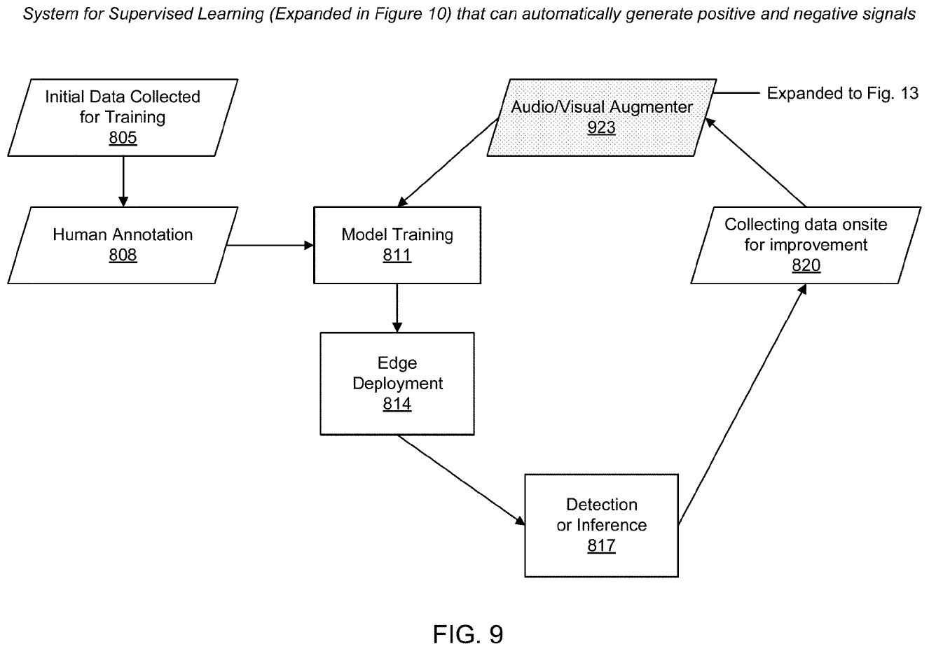

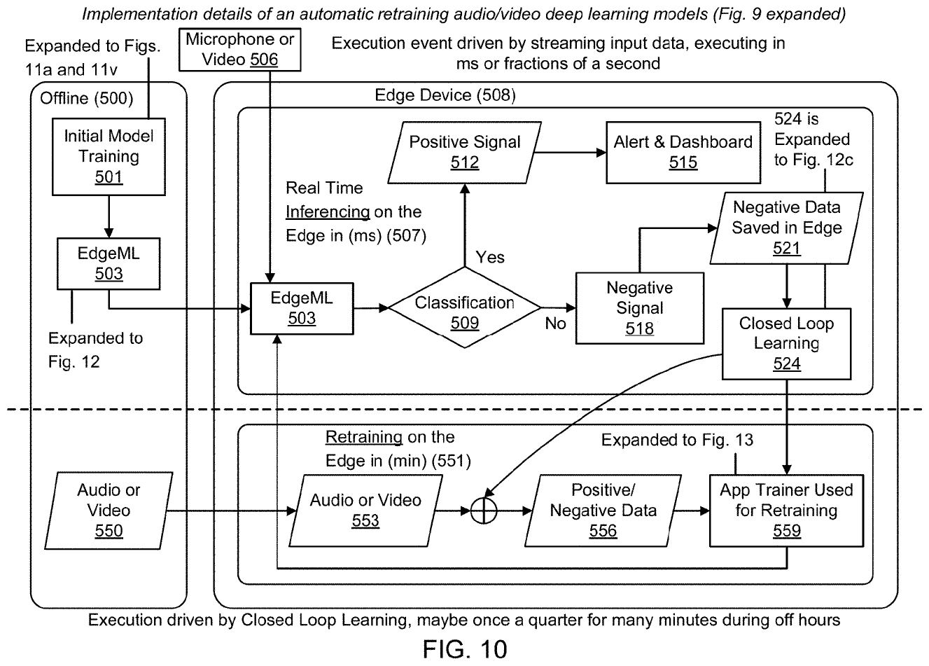

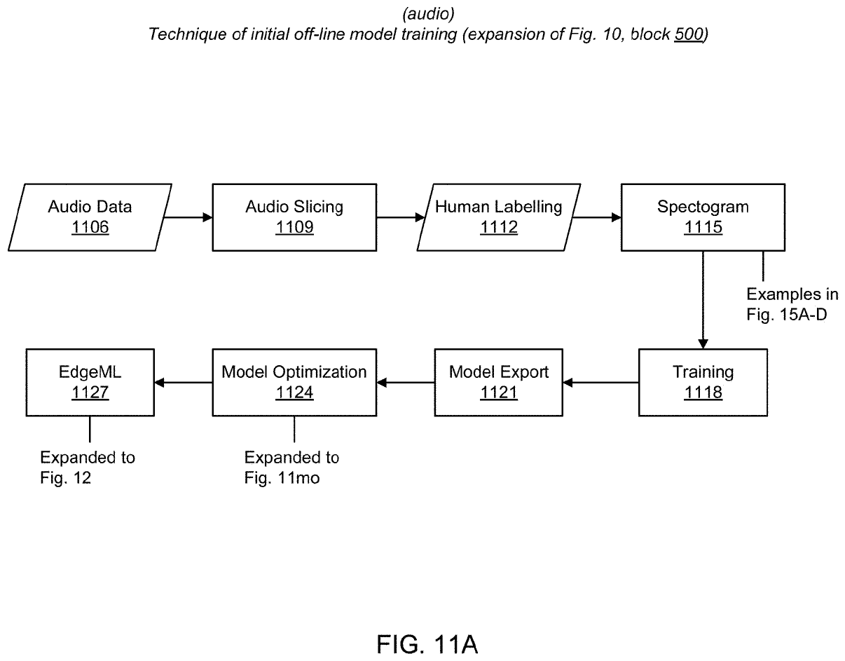

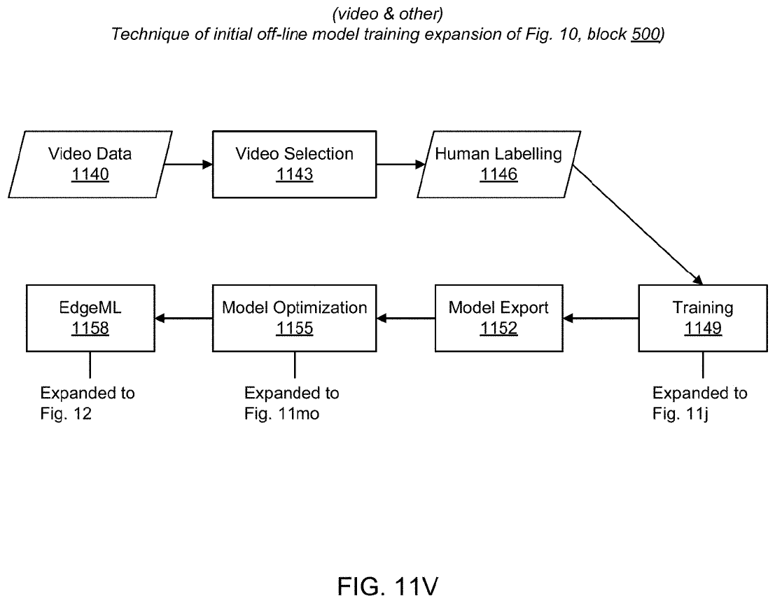

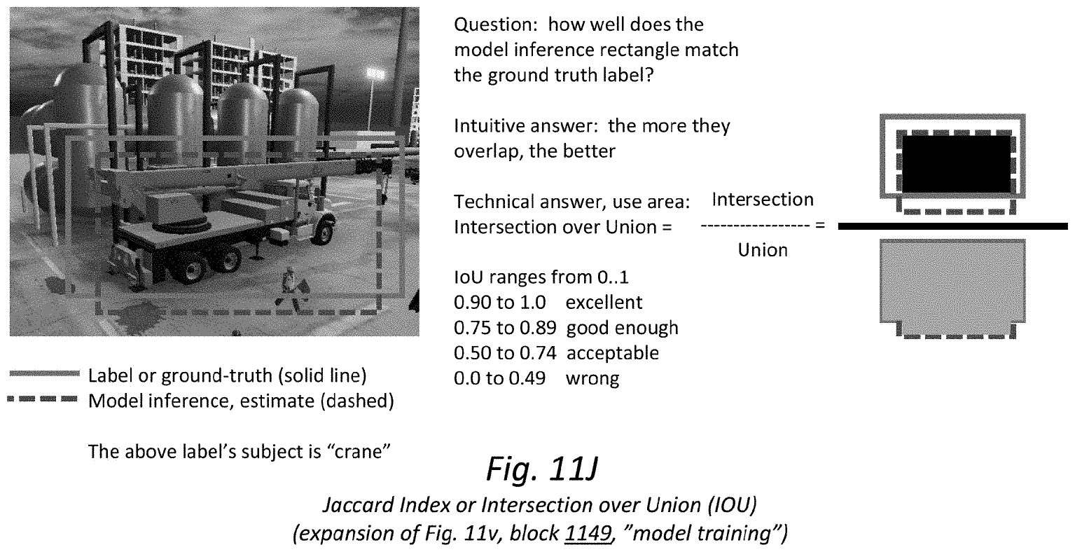

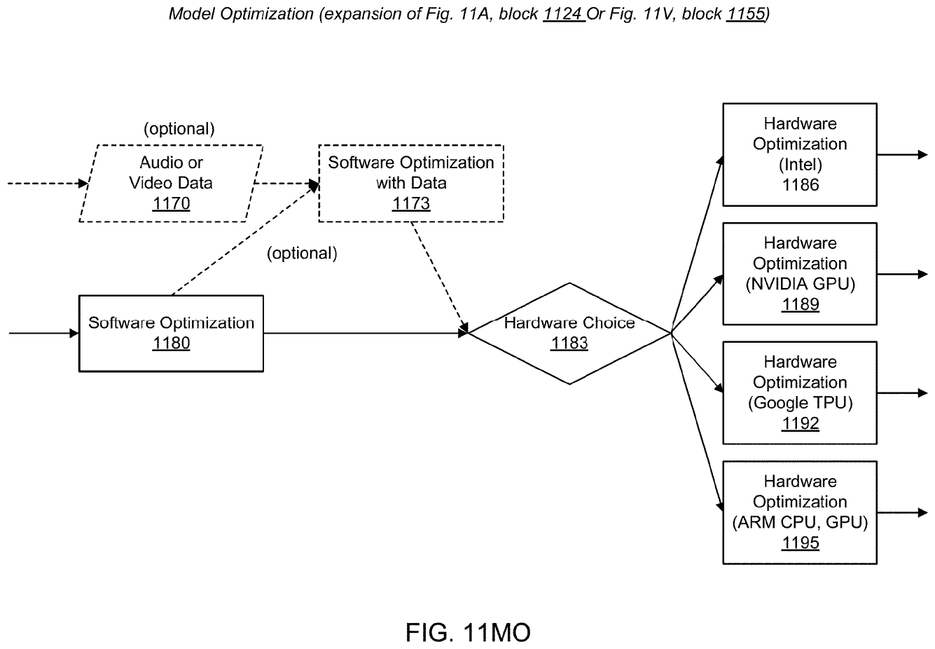

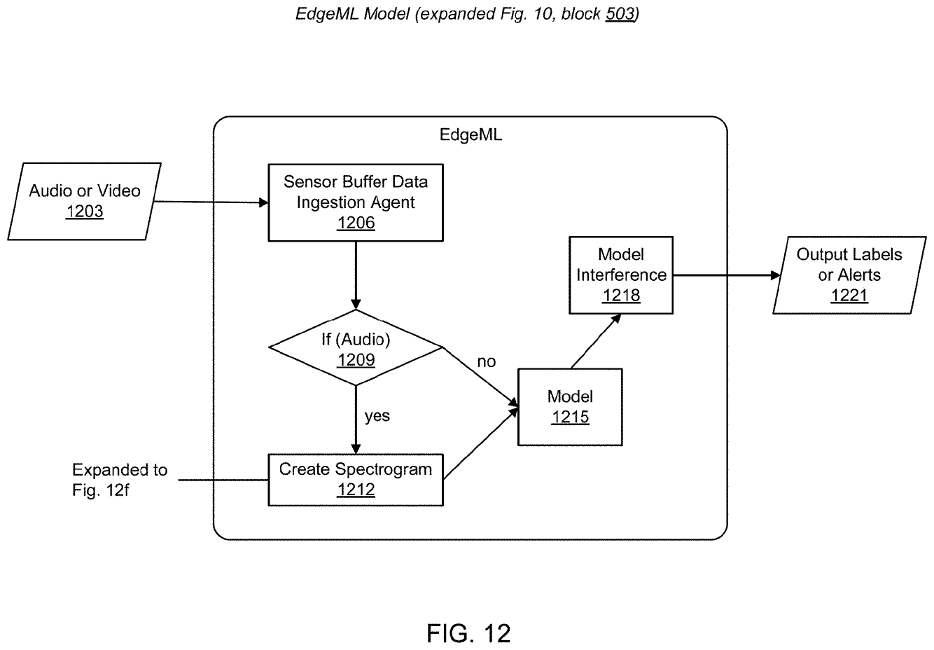

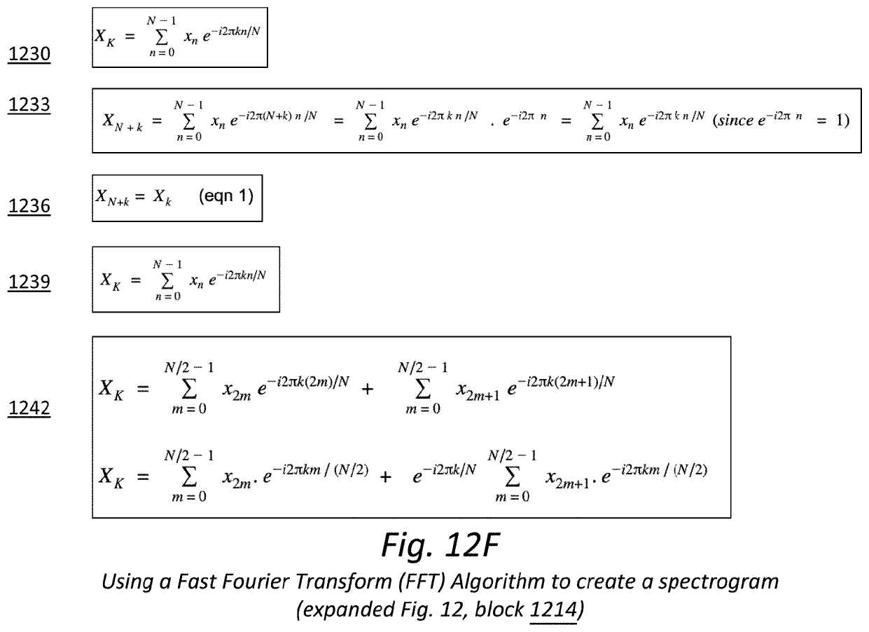

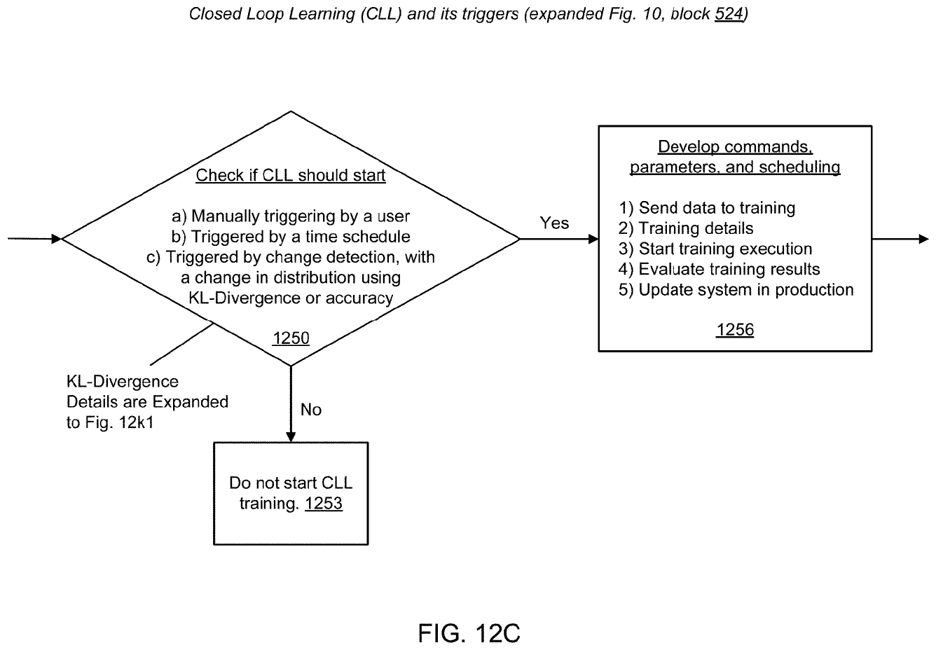

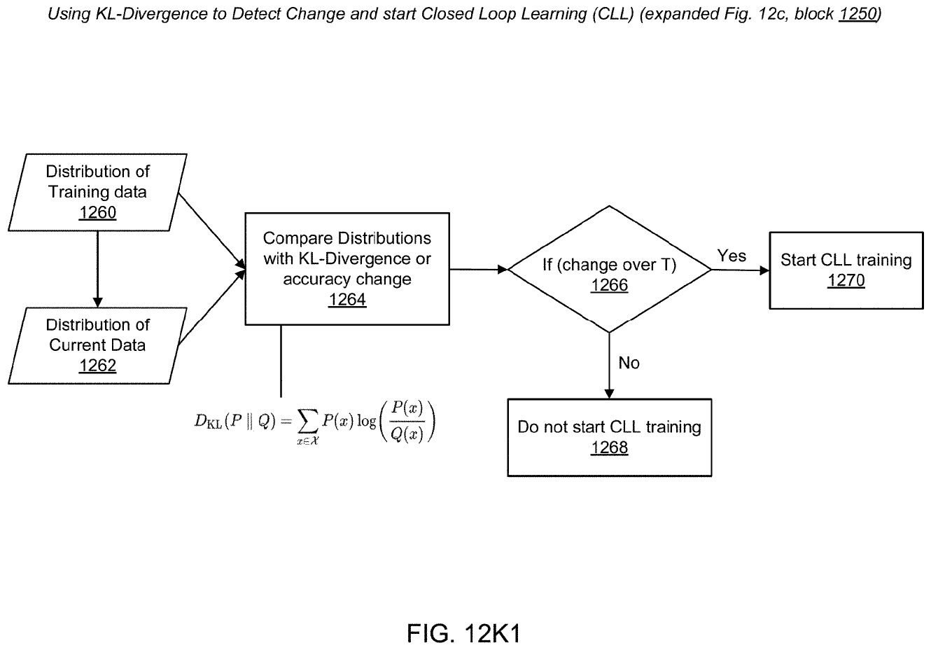

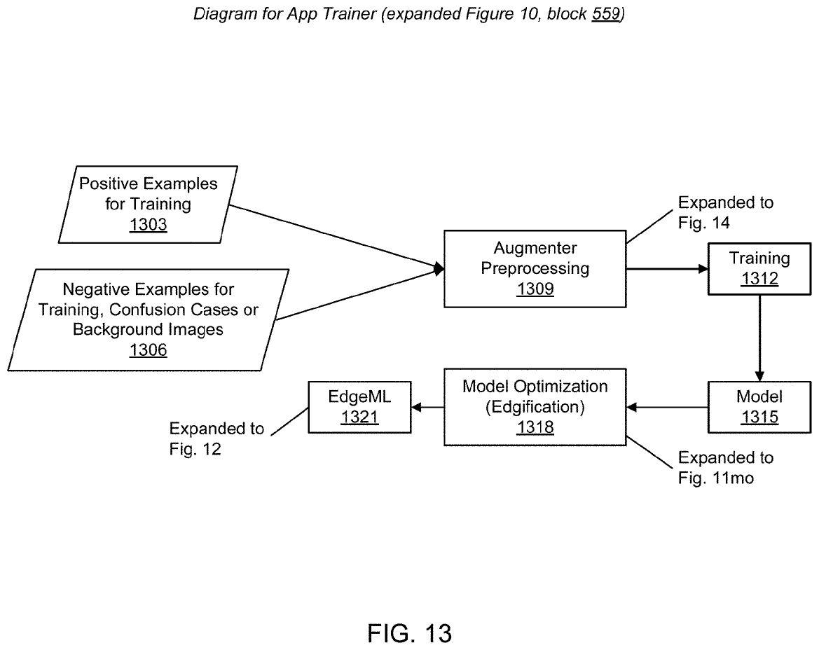

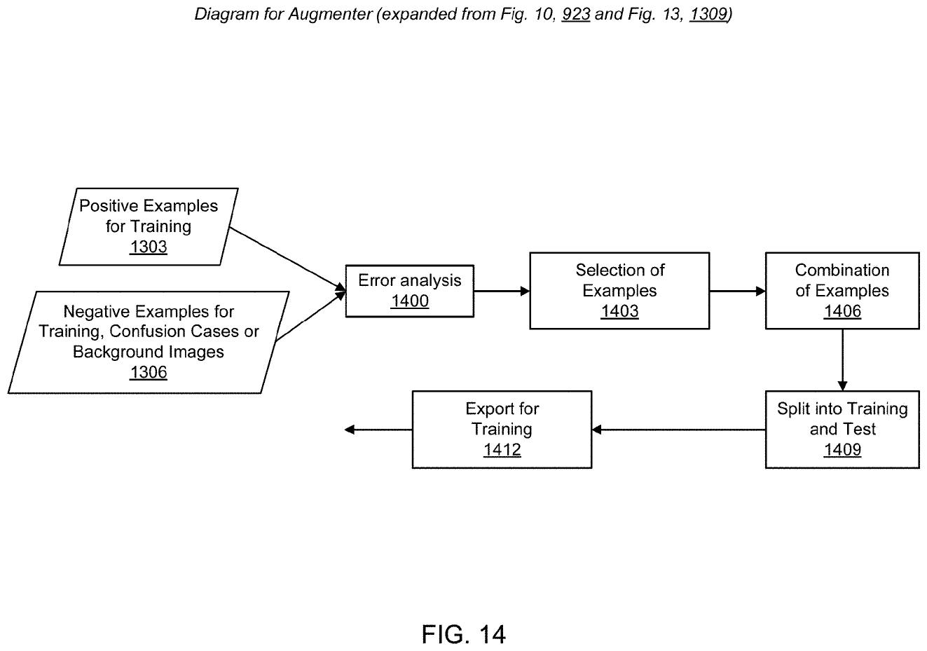

FIG. 9 shows another system for supervised learning. Compared to the system of FIG. 8, this system does not have the poor performance issue. A difference between the systems in FIGS. 8 and 9 is that in the FIG. 9 system, human annotation block (823) has been replaced by an automatically generate positive and negative signals block (923). The Augmenter is a key claim of this patent, to replace the expensive and cumbersome human annotation at the deployment site, by the customer, with an automatic system. The Augmenter in FIG. 9, block (923) becomes part of FIG. 10 block (503), is the same as FIG. 13, block (1309) and is fully expanded in FIG. 13 and FIG. 14. This process involves the following steps to enable successful detection of events by Machine Learning algorithm and do retraining without the need for human intervention. FIG. 10 shows an implementation of the FIG. 9 with more details.

FIG. 10, before going over steps, it is helpful to give overview of the larger components in the figure. “Offline” (500) refers to “not on the edge,” and includes computing environments like: NVIDIA GPU, portable, server, cloud, mobile, cluster of any or other computing environments. Offline also refers to “in-advance of deployment at the customer site.” This refers to prior data gathering, labeling, model training and any other preparations of the artificial learning application before deployment at a customer site.

FIG. 10, “Edge Device” (508) refers to a computing resource near the sensors, near the activity being managed, or with fast enough network access that distance is not an issue. Typically, this is at the client site. This includes but is not limited to: a hardened or ruggedized industrial computer, a mobile phone, a compute resource wirelessly connected to the sensor data feeds or a gateway to the sensor data feeds, a local device with compute resources.

FIG. 10, “Real time inferencing on the edge in milliseconds” (507) refers to software execution, driven by sensors streaming in data. The sensors may be any type of audio or visual device including, but not limited to, a microphone, video camera or other sensors.

FIG. 10, “Retraining on the edge” (551) refers to software for model refreshing or retraining on the same edge with “fresher” site data, not available in the offline training. This may take minutes or hours, and may be scheduled during a time of the week when the inferencing activity is lower or paused, such as outside of work schedules. This is initiated by the Closed Loop Learning (524). When the Edge device is setup, any offline data may be used for model retraining. The design is to minimize communication requirements between offline and the edge, as is practical. In contrast to real time inferencing (507), which is in a real time data streaming mode, the retraining on the edge (551) is in a batch processing mode.

FIG. 10, Step 1: At the first block titled Initial Model Training (501), the machine learning model is trained. Initial Model Training (501) is described in greater detail in FIG. 11A for audio data or FIG. 11v for video or other data. At this time in the data flow, the type of Edge hardware (e.g., Intel, GPU, TPU, ARM, or other) should be selected as a hardware parameter setting and passed along with the data flow as configuration metadata. The hardware type will be passed through the system and used in FIG. 11MO, Hardware Choice (1183), to select the hardware optimization. This is important to understand early, as some of the smaller platforms, like Intel Neural Compute Stick or Google TPU are more limited in RAM or memory available, which prevents loading larger models. Also, not all execution hardware supports all model architectures (outside of the memory limitation). For example, as of the time of writing this patent, The Google TPU system does not support medium and larger EfficientDet models (e.g., D3 to D7x). Intel has certain CPUs, such as the Celeron, which have an AVX512 to greatly speed up 8-bit integer multiplies. It is important to not just pass on the edge manufacturer, but also the chip model. The initial model offline training may be automated or a manual process. Such hardware constraints on model development should be understood as early as possible in the development cycle, or check with the client if the edge hardware can be changed.

FIG. 10, Step 2: At the end of Initial Model training, the model is exported to an EdgeML version installed on an offline computer system. EdgeML may refer to a machine learning model which is exported to and installed upon an edge device. The output of the offline EdgeML is a zip file. In some embodiments, the machine learning model may be bundled with one or more scripts within the EdgeML zip file. For example, the machine learning model may be bundled with a script for at least one of an inference event, a training event, a pure audio event, and an infra-red or distance sensor event. As part of this step, any offline audio or video (550) would be copied on to the edge, for future use in retraining on the edge with audio or video data (553). This includes labelled positive and negative data, including confusion cases. This would complete an application installation step, reducing the need to maintain a connection between offline (500) and the edge device (508). EdgeML (503) is described in more detail with respect to FIG. 12. In some embodiments, the current version of the EdgeML will be updated with a new version if the machine learning model is retrained (e.g., by App Trainer at 559).

FIG. 10, Step 3: The zip file exported from the offline EdgeML (503) is copied to another installation of EdgeML (503) on the Edge Device (508) for real time inferencing (507). The zip file is read and controlled by an EdgeML (503) running on the Edge device (508).

FIG. 10, Step 4: As audio or video data is streamed in from a microphone or video camera (506) into the Edge Device EdgeML (503) which applies a model inferencing. In some implementations, the edge device runs a preprocessing script for buffering the signal received from the microphone or video 506 to a particular length to feed into a machine learning model at EdgeML 503. The entire “real time inferencing” (507) happens quickly in short bursts, taking fractions of a second to execute, such as in milliseconds (ms). The start of real time inferencing (507) is triggered by as input signals come in from the microphone, video camera or other sensors (506). The application and EdgeML controls the sensor sample rate. In computing terms, this is considered “data streaming mode,” where each record is completely processed one at a time.

FIG. 10, Step 5: The model inferencing confidence score is thresholded, resulting in a classification decision (509). Specifically, the model inferencing confidence score may be used to automatically detect an event such as particular sound from an audio source or a particular image from an imaging source. If the data stream is audio, the entire audio is classified as having the audio subject of interest (such as a cough) or not. If the data stream is video, parts of the image frame may be identified with none, one or more generated bounding rectangle or polygon, along with the label name for that subject of interest and a confidence score. A video frame or video segment can go down both the positive and negative signal paths, based on the subjects of interest found. If the overall software application that includes this machine learning model allows users to identify problem inferencing, then this data can be tracked for later use in the Augmenter. This may be a low friction effort, similar to an email user clicking on a “spam” button, to identify a problem email. In this system, the end user can click on an “inferencing problem” button on some image on display. This is much lower effort than labeling. The “inferencing problem” equals true metadata would be later used in FIG. 14, box 1400.

FIG. 10, Step 6: Given post-processing application specific rules that trigger alerting in the detection block, a positive signal (512) or negative signal (518) may be sent.

FIG. 10, Step 7: If it is a positive signal (512), an alert may be sent to a dashboard (515). The same positive alert may be sent via email or SMS with the audio/video attachment. Alerts can be routed also to email, SMS/text messages or other channels, as appropriate for the application. As desired, the data can be saved in a data store.

FIG. 10, Step 8: The negative signal (518) can be saved to a data store in the Edge, which can be accessed for later training on the edge or reporting.

FIG. 10, Step 9: Closed Loop Learning (524). The next block, “Training on the Edge” (551) is triggered less frequently by “Closed Loop Learning” (CLL) (524) than the real time inferencing. When closed loop learning does trigger training on the edge (551) to execute, the execution may take a few seconds, a few minutes, or hours, depending on how it is configured, the amount of training data and compute resources on the edge. It is important for the training execution to be done in the background, on a lower priority, to not interfere with the real time inferencing on the edge. If the application is primarily used during work hours, the Training on the Edge (551) may be run during nights or the weekend. Closed Loop Learning is expanded in FIG. 12c.

FIG. 10, Step 10: When Training on the edge is triggered, any existing data, originally from offline audio or video data (550), now on the edge (553) is combined with negative data saved in the edge from real time inferencing. The training may be scheduled or in a “nice” background mode.

FIG. 10, Step 11: The result of the combination of offline data (550, 553) and real time inferencing data is (521, 524), produces the positive and negative data (556), which is sent to the App Trainer (559). The app trainer is expanded to FIG. 13.

FIG. 10, Step 13: The result of the app trainer is a zip file that is sent to EdgeML (503) to update the real time inferencing (507). Block (503) is expanded to FIG. 12.

FIG. 11A has the flow for audio streams, and FIG. 11v has the analogous functional flow for video or other sensor types. The audio stream will be described first. During the description of the video stream, some redundant text will be shortened if the process is the same as the corresponding audio step. FIG. 11A, step 1: The Audio data (1106) is created by data collected from various sources like client provided data, staging, the internet, test installation, and others. The data shall cover wide use case scenarios expected to occur in the future production environment. This will give the model the best possible chance of performing well in the deployed scenario. A model's robustness in future scenarios is dependent on the anticipation of the variety of future conditions, and including those conditions in the training and test data. However, this does not guarantee to cover all possible future various scenarios that could happen at deployment time, especially confusion cases that have not been anticipated.

FIG. 11A, step 2: The audio data is sliced (1109) into x time-second segments. Variable x is based on the time length needed to find features required to make classification. As an example, the time slicing may be 20 millisecond increments.

FIG. 11A, Step 3: A human will go through the data and label (1112) the audio as positive and negative examples for the Machine Learning model to learn.

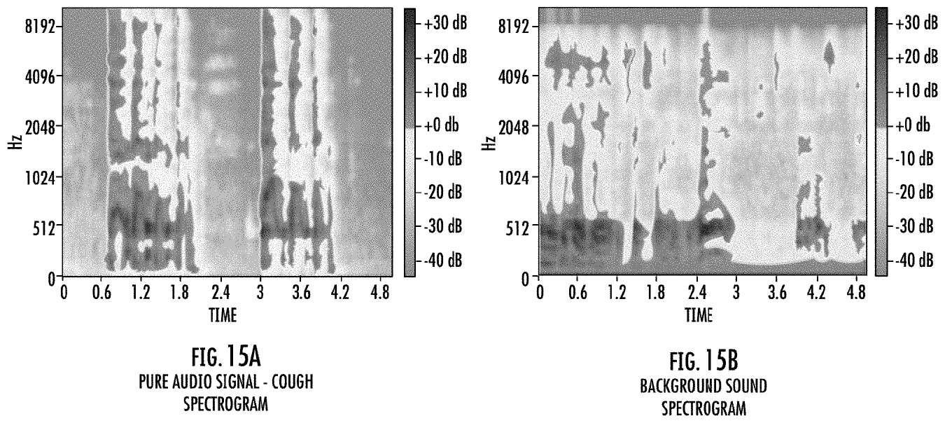

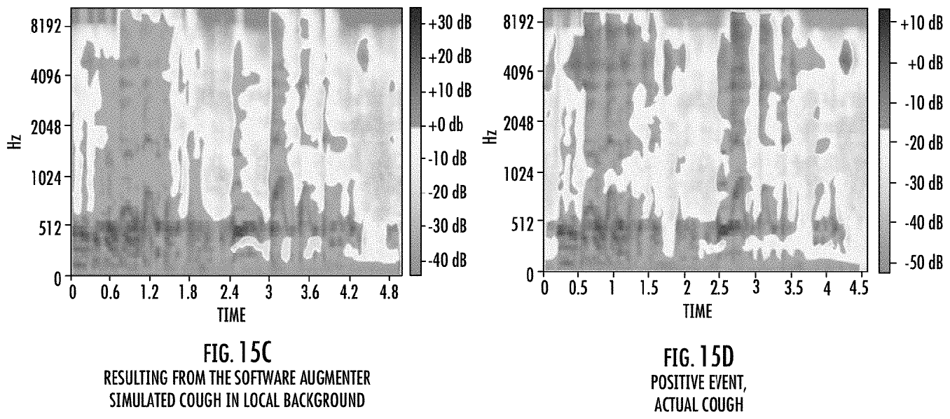

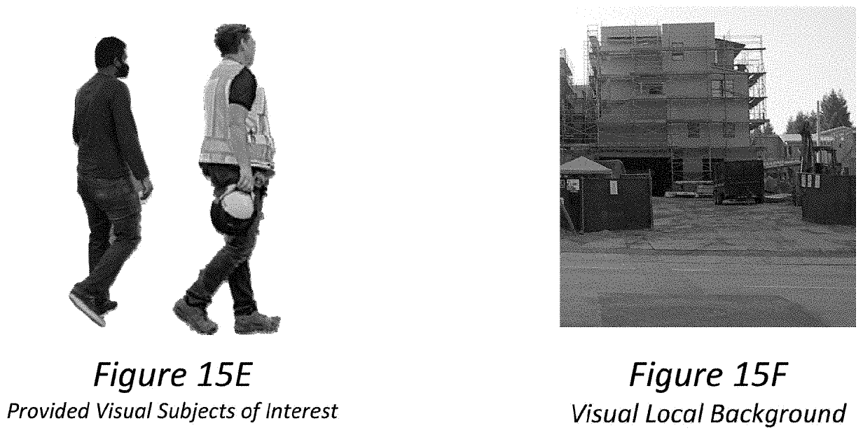

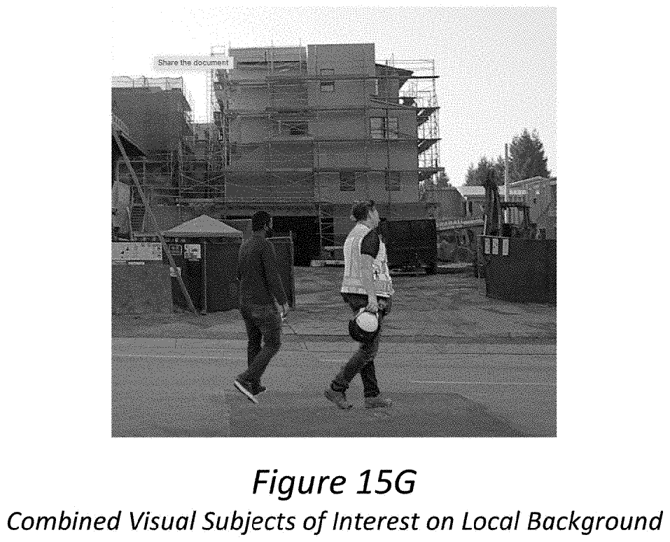

FIG. 11A, Step 4: The audio data is then transformed to spectrograms (e.g., representation of frequencies of signal as it varies with time) (1115). This audio process is not limited to just the human audio range, but any vibration or sound range that can be recorded by a sensor. FIGS. 15A to 15D show examples of spectrograms. The input to the spectrogram preprocessing is a single time series. The output is a rectangle grid with a Y-axis of frequencies (e.g., like keys on a piano), and an X-axis of short time ranges (e.g., 10 milliseconds). The cells of the grid represent energy level or volume (like a mountain range, with the height of the mountain representing the energy level). A “piano chord” played for 5 seconds would show up as 3 mountain ranges at the frequency of the piano keys, for 5 seconds. This is the standard way a spectrogram represent the sound to the model. This also links how this process generalizes over “rectangles of audio representation” or “rectangles of video image frame” inputs to the model.

FIG. 11A, Step 5: The machine learning model trains (1118) on the spectrogram and reduces the defined loss function.

FIG. 11A, Step 6: Once the loss converges, the model is exported (1121).

FIG. 11A, Step 7: The exported model is run through model optimization or “Edgification” (1124). Model optimization is a process for hardware and software optimization of a model for inferencing or scoring on the edge. The objective of model optimization or Edgification is to speed up the application of analysis, or to reduce the computing power required to support a given number of inputs such as cameras. The model optimization would depend on the target hardware computing device and the required precision as determined by the application and client preferences. Model Optimization is expanded to FIG. 11MO.

FIG. 11A, Step 8: The result of the model optimization is exported to EdgeML (1127), which is expanded to FIG. 12.

FIG. 11V, Step 1 (repeating video steps, similar to audio steps as in FIG. 11a). The Video or other sensor data (1140) is imported into the system.

FIG. 11V, Step 2 The image frames are selected from the video (1143). It may not be all frames, but every N frame, enough for a visually obvious change (e.g., every 2 or 5 seconds).

FIG. 11V, Step 3: A human will go through the images and “label” (1146) sections of a given image, with a rectangle bounding box or a polygon around the “subject of interest” to be detected. For the rest of this document, treat the labeling terms “box”, “rectangle” or “polygon” as synonymous. While the distinction of rectangle versus polygon is important to selecting a neural network architecture, with respect to the methods described in this patent, the methods are the same. The box will be given a consistent text label to indicate the subject to interest, such as “person,” “hardhat,” or “mask.” The labelers will also label any confusion cases (negative cases) to help with future model retraining. The labels in video system are functionally equivalent to the positive examples in an audio system. The unlabeled background in the video system is functionally equivalent to the negative examples of the audio system (lack of a positive). Also, any confusion cases are considered negative examples. A given video image may contain both positive and negative cases (which is not a problem for the training system). Different media or sensor types (audio and video) are not exclusive because a video camera also carries audio. Some video frames may not have any labels, some may have 20, depending on the contents of the specific image frame.

FIG. 11V (this paragraph is a comment on the contrasting step that only in audio (1115), but not video). The video system does not execute a corresponding spectrogram (1115) preprocessing step. For video files, the image data is read in 3 color channels, such as red, green, and blue (RGB). If the video is infrared (IR) there is one channel for brightness. Other sensor types can be used in this process, such as distance sensors like LIDAR (Light Detection and Ranging) or TOF (Time of Flight), with each pixel in a rectangle “image” grid representing a distance, such as 4.35 meters from the camera.

FIG. 11V, Step 4: For the image, training (1149) with a defined loss function, such as “Intersection Over Union (IOU)” or Jaccard Index between the person generated label and the model generated label estimate. Any other sensor type at different frequency ranges returned in a rectangle grid would work equally well with this process which may include frequencies outside of visible range, like X-ray or microwave. If the two labels (training and inferencing) overlap over 50 percent, it is commonly considered a successful recognition. Other optimization metrics may be used.

FIG. 11v, Step 5: Once the error loss converges, the model is exported (1152).

FIG. 11v, Step 6: The exported model is run through model optimization (1155). The type of model optimization would depend on the target computing edge device and the required precision as decided by the application.

FIG. 11v, Step 7: The Edgified model is sent to EdgeML (1158). EdgeML is expanded to FIG. 12.

FIG. 11J. To elaborate on the Jaccard Index or IOU metric, this metric is used to evaluate how well a vision (or other sensor) detection system finds the correct bounding box around a subject of interest, such as a person, or a crane. The areas of the two bounding boxes are compared. One is the box for the ground truth from the labeling process (the solid line box in the figure). The other is the box from the model inferencing generated bounding box (the dashed line box in the figure). The best possible match is when the two bounding boxes (truth and inference) are the same size, the same aspect ratio, and overlap completely. However, many “close matches” are good enough, where the inference bounding box may have a slightly different aspect ratio, one side may be too far to the right by 5 percent and the bottom may be too low by 8 percent. This metric calculates a ratio of the intersection of the two boxes (shaded black in the figure), divided by the union or combined area of both boxes (shaded grey in the figure). Hence the name “Intersection over Union”. Usually, an accepted range is an IOU of 0.5 to 1.0, with a larger value indicating higher accuracy. IOU values of 0 to 0.49 are considered an error or mistake.

FIG. 11MO: This figure on Model Optimization expands FIG. 11A, block 1124, and FIG. 11v, block 1155. The model optimization is a wrapper providing integration (FIG. 11MO), automation, performance testing and accuracy impact testing of many different optimizations, from best practice research papers and software libraries. It also reduces redundant software optimizations common across multiple hardware platforms. Overall, the input is a model, and the output is a model that runs faster on the edge. Benefits include, but are not limited to: (a) running a video model at a faster frames per second (FPS), or (b) running the same model at the same speed with less expensive hardware, (c) running more sensors (audio, video or other) through the same level of edge computer, or (d) using less RAM or memory in production which can reduce hardware costs, or allow more models to be loaded in RAM

FIG. 11MO, Step 1: Software optimization (1180) primarily operates on the existing, static input neural network model. This groups all optimizations that are not specific to the final execution hardware. This includes, but is not limited to a) analyzing and identifying the neural network architecture, such as Mobile Net, Inception, ResNet, Faster RCNN, Mask RCNN, EfficientDet or a manual architecture. B) Reduce the bits per neural network weight, which is called quantization. By default, when trained, models are trained with 64-bit floating point numbers. All the weights can be compressed to 32- or 16-bit floating point numbers. The weights can be shrunk or quantized to 8 bit or smaller integers. Compressing to 16-bit floating point numbers rarely causes a loss in accuracy. Quantizing to 8-bit integers may cause a 2-3 percent loss in accuracy (which may be a client choice in some cases). The benefit of the weight quantization is shrinking the model size in RAM or memory. Going from 64 bit to 16 bit is a very safe way to reduce model size by a factor of 4. C) Merging adjacent linear and non-linear layers, such as a weight matrix with a non-linear transform function. The benefit is this reduces the number of sequential steps or operations to run one data record through the model. Each layer and convolution is a different sequential step. The merging of adjacent layers can reduce the number of sequential steps by 30 percent to 50 percent. D) Grouped convolution fusing with one-dimensional, two-dimensional, or three-dimensional convolutions. The input is split into groups and then group filters are applied.

FIG. 11MO, Step 2, Audio, video, or other sensor data can be fed into the Model Optimization system, to enable additional optimizations. Providing data for model optimization may not always be desirable, because it requires more client effort or friction. However, it can provide dynamic model optimization benefits, enabling retraining and model updating.

FIG. 11MO, Step 3, Software Optimization with data (1173). As inputs, this requires both data from (1170) and the corresponding model resulting from Software Optimization (1180). The output of this step is a more optimized model. This step provides a number of optimizations, including but not limited to (A) quantization aware training and accuracy aware training, which can enable quantizing or compressing different weights a different amount, to balance model shrinking while minimizing accuracy impact. Some weights are more impactful to the model and need higher resolution, other weights are used in corner case situations or don't need as much resolution, and can be compressed more. (B) Pruning convolutions, which are the smallest pattern detector in the neural network that can be pruned in TensorFlow. Before training, the neural network weights are either initialized to small random values. In transfer learning, an existing network that has learned 1000 or 5000 objects, which may be may be reused in training new systems, such as for a current application that needs to detect 2 to 50 objects. During the training process more of the convolutions get used as pattern detectors. However, many convolutions remain barely used or unused and represent unneeded computation during inference time on the edge. One way to prune convolutions is to run data through the model, recording the output of each convolution considered for pruning. Aggregate the output activations with an average and standard deviation and sort by one of the aggregations. The convolutions with weights closest to 0, or have the smallest standard deviation are good candidates for pruning. Near zero weights have little impact, 0 would have no impact on the score but still require computation resources. If a convolution always outputs the same value for every input record, it is also not useful. To minimize accuracy impact, use a cycle of pruning, retraining, or reassessment of convolutions, or any combination. One large pruning will speed up but have a larger negative impact on inference accuracy.

FIG. 11MO, Step 4, Hardware Choice (1183). A model flows in from either Software Optimization (1180) into this step. Back in FIG. 10, during Initial Model Training (501), the type of Edge hardware (e.g., Intel, NVIDIA GPU, TPU, ARM, or other) can be selected as a hardware parameter setting. That configuration will be passed into FIG. 11A or 11V for use in the Model Optimization Step, and passed finally to FIG. 11MO, Hardware Choice (1183).

The phrase “hardware optimization” does not change any hardware; it changes the neural net model and inferencing software to be more optimized specific to the execution hardware.

FIG. 11MO, Step 5 is Hardware Optimization for Intel (1186). Intel provides the Open Vino library, which provides optimizations for Intel hardware like CPUs, Intel GPUs, the Neural Compute Stick 2 and Movidius VPUs.

FIG. 11MO, Step 6 is Hardware Optimization for NVIDIA Graphics Processing Units (GPUs), using the NVIDIA library TensorRT. This library supports both the GPU add-in cards to an Intel/AMD CPU platform, such as used for gaming, neural net training or bitcoin mining. This also supports the Jetson family of stand-alone hardware systems which integrate NVIDIA chips with an ARM CPU. The types of optimizations from TensorRT include (a) quantization with 16-bit floating point or 8-bit integer, (b) fusing layers while optimizing GPU memory, (c) kernel auto-tuning, (d) dynamic tensor memory, (e) multi-stream execution in parallel on the GPU, (f) time fusion specifically for recurrent neural networks over time steps. Types of architectures supported includes but is not limited to: (a) SSD Mobile Net v1 and v2, (b) Inception V2 SSD, (c) Faster RCNN, (d) Mask RCNN, (e) Resnet V1_101, (f) ResNet V2_50, (g) EfficientDet

FIG. 11MO, Step 7 is Hardware Optimization for Google TensorFlow Processing Units (TPUs). Using the EdgeTPU Compiler will speed up TensorFlow Lite models. Inference on the edge can be run with either Python, or for more speed, with C++ using the TensorFlow Lite C++ API.

FIG. 11MO, Step 8 is Hardware Optimization for ARM with the ARM NN library, which supports execution hardware like Cortex-A CPUs, Cortex-M CPUs and Mali GPUs. Optimization's support 32 bit float and 8-bit integer quantization. FIG. 12, Overview description for this figure, which is an expansion from FIG. 10, block 503. The EdgeML model contains scripts that recreated the preprocessing steps that were used in FIG. 10, Initial Model Training (FIG. 10, block 501), for use in both inference and for later App Trainer used for Retraining (FIG. 10, block 559) to do the inference (FIG. 10, block 507).

Referring now to FIG. 12, the system for supervised learning described in FIG. 10 is described in more detail. FIG. 12, Step 1: The audio, video, or other sensor data (1203) is sent into EdgeML first.

FIG. 12, Step 2: The Sensor Buffer Data Ingestion Agent (1206) receives the data from 1203. For audio analysis, it takes buffered sound waves over a short time period, such as 20 or 50 milliseconds (ms). For video or other data, the fames are selected as per inferencing (e.g., 15 FPS or 2 FPS) as determined by the application and model.

FIG. 12, Step 3: If it is audio data (1209), the buffered sound data is sent to a function to create a spectrogram (1212) with a Fast Fourier Transform (FFT) algorithm. For details on FFT, see FIG. 12F. The FFT is a standard part of Digital Signal Processing (DSP). For sample spectrogram plots, see FIGS. 15A to 15D. The input to step 3 is a data stream of sound waves, which are run through an FFT to create a spectrogram matrix, which can be plotted. The spectrogram matrix is used as input into the machine learning model for inference.

FIG. 12, Step 4: Model (1215). Either audio data converted to a spectrogram or video or other sensor data is then sent to the model (1215). The EdgeML reads the current machine learning model (1215) that was on the edge. When the edge computer is booted up, the EdgeML software system would read the model off disk to load into memory, and keeps the model in memory for all other streaming inputs, for use in inferencing. During retraining it gets replaced by the new model by the trainer.

FIG. 12, Step 5: The model inference (1218) by EdgeML will feed the data into the model, to calculate the inference output. The input data could be the audio spectrogram, video or other sensor data. If the input is audio, the output inference provides the estimate if the sliced spectrogram is positive or negative signal. If video or other data, the output would include bounding boxes with labels and a confidence of the estimate. The label would be the name of the “subject of interest” specific to the application, such as “person wearing hardhat,” “person not wearing hardhat,” “crane” and so on. Model inferencing post processing can compose an alert email or text/SMS message, structure data to write to disk or other preparations to output the results.

FIG. 12, Step 6: Output labels or alerts (1221). The EdgeML system writes the prepared output to the edge computer to stream or store data for to the next step.

FIG. 12F, overview: To expand on the Fast Fourier Transform (FFT), first we will describe WHAT the inputs are outputs are, WHY we use it—and finally we will describe HOW it works.

FIG. 12F, WHAT: First, to answer WHAT the inputs and outputs are: the inputs are a vibration or waveform signal over time, such as sound or light in a time series form, also called “time domain.” Faster vibration would be higher pitch in the auditory range, or closer to purple or ultraviolet in the visual range. The time series sine waves repeat more rapidly. More energy would be louder sound, brighter light or taller sine waves. The output is a spectrogram plot or matrix of numbers, considered in the “frequency domain.” For example, spectrograms, see FIGS. 15A to 15D. On the spectrogram, the horizontal X-axis represents small steps in time, such as 10 or 20 milliseconds. The Y-axis represents frequency, from low to high. You can think if the Y-axis as corresponding to notes on a piano keyboard, or colors on a rainbow. The cells of the spectrogram represent energy (e.g., volume or brightness) for that time window, for that frequency. The color scale in these plots goes from the highest energy with red color, to middle energy in white, and low energy in blue. If you were to play a chord of three keys on a piano pressed for a second or two, the spectrogram would show high energy at those three frequencies for a second or two. It would look like three horizontal mountain ranges in the spectrogram plot that jump up from silence in the beginning and gradually taper off to silence.

FIG. 12F, WHY do we use a spectrogram? Because it gives a good numerical or graphical representation of energy by frequency component over time.

FIG. 12F, HOW does the FFT algorithm work? The Discrete Fourier Transform (DFT) is given by (1230). Where Xsub(k) (or Xk) is in frequency domain while xsub(n) or xn is in time domain. The computational complexity of DFT is O(N\hat{ }2). Fast Fourier transform (Cooley-Tuckey algorithm) computes the DFT faster by exploiting the symmetry of the above equation. Let's derive the basis of symmetry first (1233). Thus, we have (1236). Now coming back to Discrete Fourier Transform we have (1239). The above equation can be written as sum of DFT of even index and odd index (1242). Here note that k goes from 0 to N while m goes from 0 to N/2-1. This means that from what we know from equation 1, we need to calculate only half the values for even and odd components. Further, this could be done recursively as in divide and conquer algorithms, splitting the equation further and further, until it reaches the size where further halving is not computationally beneficial. The resultant computational complexity is O(N log N) as compared to the O(N\hat{ }2) of DFT.

FIG. 12C, Step 1: Closed Loop Learning (CLL) and its triggers in block (1250). This Figure is an expansion detail from FIG. 10, block 524. Block (1250) checks if CLL should start, which is the exception. Normally, the model continues to run inference mode as data streams in. WHY do we need this block? Over time as behaviors change, the model needs to be updated. The model's structure and behavior is set when it was most recently trained, with the “fitting” to the data and the behaviors of the systems represented by that data. For an Internet of Things (JOT) problem dealing with machines, if a machine slowly gets out of calibration but still operates normally, that is an example of behavior drift of the system. For marketing problems, if competitors launch new products or significantly change their pricing structure since the model was trained, that would be a behavior change. The current marketing systems behavior has drifted versus the original data, used for training. Different types of systems have different rates of change. Internet advertising banner ad models may be automatically retrained every night. IoT factory production of devices models may not change until a significantly new product line is added or a change in the manufacturing process.

FIG. 12C, Step 1 (1250) (continued). WHAT are the ways CLL could be triggered to start? (A) The system could be manually triggered by an installer, after the model is first moved to the edge and the first batch of client data is loaded. The system could be triggered by a user for other, external reasons (such as a known product change). (B) The system could be triggered to start retraining based on a fixed time schedule, such as “every 3 months.” (C) If set into “change detection” mode, then CLL will compare and analyze the recent current data against the original training data. The comparison does not require all the raw training data, but makes use of a data sample and/or metadata, depending on how it is configured. The chance detection uses KL-Divergence formula to compare two different distributions. A larger divergence value indicates a larger change in behavior. The details for KL-Divergence are expanded in FIG. 12K1. Alternatively, change detection can look at a change in accuracy metric, by calculating the difference in an accuracy metric over training data to the current data. Then trigger retraining by using a threshold to identify a large difference. Accuracy metrics include but are not limited to: percent correct, precision, recall, F1 (a combination of precision and recall), confidence, R-squared, correlation, ROC curve thresholded.

FIG. 12C, Step 2, Develop commands, parameters and scheduling for CLL, block (1253). (1) sending the data to training, how to combine local site data with the prior offline data, how to focus on any issue or problem images marked by the client. The issue images are duplicated at a higher rate to increase their impact on the training. (2) The training parameter details, specific to the parameter search for the model architecture and what was found most effective during the offline model training. (3) Use any system configuration parameters to determine the time frame for training during the low or no volume inferencing. (4) Evaluation metrics for the model, both overall, by label, by alert rule and by available metadata covering context (e.g., sensor location, time of day, and so forth). The evaluation metrics are important, because the provide Key Performance Indicators (KPIs) to repeat the loop and continue model improvement. (5) After one or more model training and evaluation loops, the model can be put into production, moving the model from offline training on the edge (FIG. 10, block 551), to Real Time Inferencing (507), to box (503), EdgeML.

FIG. 12C, Step 3, Do not start retraining (1256). This is the most common situation. If inferencing occurs many times a second and CLL starts once in a few quarters, then this block is reached, e.g., 99.99 percent of the time.

FIG. 12K1. Before describing the steps in this Figure, it is helpful to describe reasoning behind the design of this Figure. The background reasoning starts with (A) Why do models need to be retrained? Define terms like data drift and model drift. (B) a definition of the term “distribution.” (C) How to select meaningful fields for use in change detection? (D) How can change detection on those fields be useful in triggering model retraining? (E) What fields are best to check for change detection? What fields have the most semantic meaning from a Convolutional Neural Network (CNN) deep learning model? (F) How to apply change detection on semantically meaningful values to trigger useful to model retraining.

(A) Why do models need to be retrained? A supervised model is optimized to “fit” the behaviors represented in the static training data, and evaluated with the static hold-out test data. The “model fit” to the behavior in the data is like the shape of shrink wrap plastic around a retail electronics product. The plastic has a 3-dimensional curved surface around the bumps of the product, like a mountain range. Crossing the product horizontally and vertically is like an X-axis and Y-axis distribution (distribution will be discussed more below). For a deep learning model, the curve for “predict detecting a person with helmet=0.90” is a curve in millions of dimensions (over millions of model weights). The curve for “predict detecting a person with helmet=0.85” is a similar, frequently parallel-like curve. While the training and test data are static, or stationary in mathematical terms, what happens in the real world is non-stationary. Human processes change slowly over time, human decisions change over time. The “data drifts” as behavior gradually drifts. In contrast, there is no “model drift.” The model can be reloaded from disk, where it has not changed. Some minor behavior changes may not affect the model's performance. Over time, more and more small changes will be reflected in decreasing model performance as the current model's “shrink wrapped plastic curve” no longer fits the data.

(B) What is a “distribution”? A distribution answers “What percent of the values of a collection of numbers fall into each of N bins?” A retailer may ask “What is the percentage of sales revenue by day of week (where N=7)?” The number of bins may be defined by another categorical field, or may be set by a design, such as “20 equal frequency bins.” Then the distribution determines the bin split points. In this case, the bin split points become the metadata to share. Saving only the distribution split points, instead of all the data, gives a substantial compression on the data that needs to be saved over time.

(C) How to select meaningful fields for use in change detection in a traditional model with named fields? The primary change detection of the target, with additional change detection and descriptive benefits from the most meaningful input fields. For “traditional data mining models” with “named input fields” with clear meanings and field names like “pressure,” “temperature,” “current,” each field would be a different collection of data, or numeric values for distributional analysis. The target output or inferencing would be another collection of data. With the selected fields (target or primary inputs) break them in to 20 equal frequency bins, saving the bins split points from the training data for future comparison over time with ongoing scoring data. Primarily, perform the same binning and change detection on the target distribution. For a traditional data mining model, each of these named fields has a separate semantic meaning, which is clear and can be described.

(D) How can change detection on those fields be useful in triggering model retraining? First, check for a change in distribution of the target distribution. If there is a change over a threshold then trigger retraining. For better understanding, check for a change in distribution for the most predictive fields, the fields most meaningful to the model.

(E) What fields are best to check for change detection? What fields have the most semantic meaning from a CNN model? The output confidence score for the CNN object detection model would have one set of outputs per label, including a confidence score. The CNN audio model could either have a time range for a specific audio subject within the input, or could have an output score to classify the entire input as a particular class, such as “cough” versus “no cough.” CNN models do not have named input fields, just input pixels. The objects to detect can shift around to any pixel location in the input image data structure. There is not a semantic meaning behind certain locations in the input matrix (e.g., image or spectrogram). For a CNN model, the semantic meaning is in the higher convolution layers. In contrast, lower-level convolutions detect small, detailed features that are later combined to create the higher levels of meaning. To give an example, when detecting a person's face, lower-level convolutions may detect things like: horizontal line, vertical line, diagonal going down to the right. A higher layer may detect: part of a nose, part of a mouth, part of an eye. A higher (combining lower layers) may detect: full narrow nose, full wider nose, full nose type C, full mouth A, full mouth with mustache, full mouth with mustache and beard. A higher layer may detect: lower face type A, right face type M, and so forth. A higher layer starts detecting: full face for Sam, full face for Sue, full face for Tom. The output would provide a bounding box location around the face along with a confidence score for recognizing that person or label. For the CNN, the input pixels have no consistent semantic meaning, but the higher-level convolutions do have a higher-level meaning.

(F) How to apply change detection on semantically meaningful CNN values to trigger useful model retraining? Select the top third of the convolutions in the architecture (not skip connections, residual connections or other variations). To get the distributions, run either training data or the more recent inferencing data through the neural network, saving the output for each record for each convolution. Calculate the distribution split points per convolution from the training data, and apply those fixed split points to the inferencing data and observe the resulting distribution. How does this help? If there is a substantial change in medium and high-level patterns the network is detecting, that indicates there is a change in what is happening in the general environment.

FIG. 12K1, Step 1: Distribution of Training Data (1260). At the time of the most recent training or retraining, select the fields for distribution analysis and read the configuration parameter on the number of equal frequency distribution bins to create a distribution of training data. Save the fixed bin thresholds as metadata for later use in change detections. Send the fixed bin distribution thresholds to (1262) to calculate the distribution of the current data (1262). Send the percent distributions to the comparison step, (1264). Alternatively, if accuracy is being used, calculate the accuracy metric in (1260) and send to (1264).

FIG. 12K1, Step 2: Distribution of the current data (1262). Using the bin split points per field from the training data, calculate the percentage distribution within each bin in the current data. If accuracy is being used, calculate the same accuracy metric in (1262) and send to (1264).

FIG. 12K1, Step 3: Compare distribution with KL-Divergence (1264). The KL-Divergence formula is expanded in FIG. 12K1. When the new distribution is very similar to the reference distribution, the divergence is low. The more they differ, the higher the divergence. The result of the divergence calculation is a number, passed to the next step. There are other metrics that can be used for change detection of the output score (changing from training to current inferencing). These include various accuracy metrics, including but not limited to: percent correct, precision, recall, F1 (a combination of precision and recall), correlation, R-squared or others. Any of these can be calculated over the training and current inferencing data. Calculate the difference in accuracy from training to inferencing, and set a threshold to detect large changes.

In the KL-Divergence formula, P(x) is the reference distribution, from the training data. Q(x) is the distribution from the streaming data.

FIG. 12K1, Step 3: if the change is over a threshold T (1266). Most of the time the divergence is below the threshold, Closed Loop Learning retraining is not triggered (1268). If training is triggered (1270), then the Closed Loop Learning starts the model training on the edge (FIG. 10, 551). If an accuracy metric was selected in step (1264), then the difference in aggregate value (e.g., average or at a percentile) can be compared against a threshold to decide to trigger Closed Loop Learning

FIG. 13, Step 1: FIG. 13 is the Diagram for the App trainer (an expansion of FIG. 10, block 559). The first step is to import data, positive examples for training (1303) and the negative examples for training (1306).

FIG. 13, Step 2: The Augmenter (1309) combines the audio (with examples shown in FIGS. 15A to 15D) or video (with examples shown in FIGS. 15E . . . 15F). Specifically, the Augmenter 1309 may mix the negative examples with a pure example to create positive example which may be used to retrain the machine learning model. In some embodiments, a negative example refers data which does not include a subject of interest. For example, a machine learning model may be trained to identify a specific sound such as a cough. In such an example, FIG. 15B may be considered a negative example because it includes a spectrogram of background noise without the subject of interest (e.g., a cough). In some embodiments, a pure example refers to an isolated representation of the subject of interest without any interfering noise. For example, FIG. 15A may be considered a pure example because it includes a spectrogram of a pure audio signal of a subject of interest (e.g., cough). In some embodiments, the negative example and the pure example may be combined to create a positive example such as is shown in FIG. 15c. A positive example may refer to a realistic representation of what the subject of interest may look like. For example, if a machine learning model is being trained to identify a cough, rarely will the sound of the cough be isolated from background noise. Therefore, a pure audio signal of a cough (e.g., FIG. 15A) may be mixed with background noise (e.g., FIG. 15B) to create a more realistic representation of how the subject of interest would show up in a realistic scenario. The details of the Augmenter are expanded in FIG. 14.

FIG. 13, Step 3: The output of the Augmenter is training data used in the model training (1312) process.

FIG. 13, Step 4: The output of the model training process is a neural network model (1315) with weights optimized to recognize the positive examples versus the negative examples.

FIG. 13, Step 5: The neural network is run through the Edgification optimization process (1318). Parameters in the Edgification process include the target edge hardware that the model and EdgeML will run on. The Model Optimization is expended into FIG. 11MO.

FIG. 13, Step 6: The Edgified model is brought into EdgeML (1321). If the EdgeML model is on the edge device, it is now available for inferencing (FIG. 10), providing a classification for each streaming input. EdgeML is expanded to FIG. 12.

FIG. 14, Step 1: FIG. 14 is the expanded diagram for the Augmenter. The Augmenter block is also in FIG. 9, box 923 and FIG. 13, box 1309. Step 1 reads in the various positive and negative examples provided for training and analysis.

FIG. 14, Step 2: Performs error analysis (1400) on the provided labeled audio or video examples with their known values (from offline or a customer clicking on a sample to identify it as an “inferencing problem” from FIG. 10, box 509). The error analysis is over both the positive and negative examples provided. The error analysis looks at (a) false alerts and missed alerts overall, (b) error rates by post-processing alerting rules, as well as by (c) any populated scene metadata or (d) visual context metadata. Each of the provided training labels can have visual context metadata. Each of the cameras at the production site can be used as a source of information for visual context metadata (e.g., time of day, lighting, and so on). It can help when the provided training labels metadata is compatible with the camera metadata. Metadata may include, but is not limited to: lighting_type equals (outdoor_day, outdoor_night, outdoor_dusk, indoor_well_lit, indoor_dim), light_direction equals ( . . . ), distance equals (different distance bins or degrees of field of view divided by wide angle. Is a person 10 percent or 50 percent of image height), floor polygon equals ( . . . ), pixels per meter calibration equals (per input pixel, an interpolation of the local pixels per meter or per foot). The error analysis prioritizes the data and learning opportunities to drive model improvement. A strategic advantage is finding the new, local confusion cases. The system makes use of lowering the confidence threshold on detection can help find local confusion cases.

FIG. 14, Step 2: The selection of examples (1403) over the positive and negative examples is made based on the error analysis (if there is an error and how severe the error is). If the application allows user input to identify images with “inferencing problem” issues (e.g., false alerts or missed alerts), then that metadata is used as well to select those images with a high priority. A stratified random sampling is used to bias or focus on selection and duplication of training records on the higher error rate subsets of the available data. Duplicating training records has the benefit of giving the machine learning model more practice on problem areas. Inferencing confidence thresholds can be lowered to more easily select any possible confusion cases from the location data. The confusion cases may also be used to generate multiple training or test examples to help the model “practice” training more on the weak areas of the model.

The combination of examples (1406) is used to combine any provided subjects of interest and confusion cases to an existing local image.

For audio, the combination of examples could be implemented with either hardware or software. For audio, if using hardware, a speaker can play a given audio file near the microphone to produce the superposition effect of the event to be identified over the current environment. Conditions like distance of the source, level over the background noise could be controlled. In contrast to a hardware implementation, “audio mixer” software could be used to lay down a positive track over the existing background sounds. When combining for audio analysis, care is taken to minimize overlapping known cases with suspected background positive or confusion cases.

For video or other analysis, when combining foreground subjects and background local images, care is taken to not overlap any part of the bounding box existing in the local data with a provided known positive case or confusion case. If the visual context metadata is populated on both sides (offline and from the local site), it can be used to constrain to provide more plausible insertions of the labels in the background images (a realistic size, lighting type, lighting direction, on the ground as needed and so on). A “fuzzy K-NN match” can be used to combine provided labels that best match a given background image. This can be used to constrain to provide more plausible insertions of the labels in the background images (a realistic size, lighting type, lighting direction, on the ground as needed and so on).

The examples are split into training and test data sets (1409), such as 75 percent for training and 25 percent for testing. If there is a low data volume, cross-validation can be used. The order of the training records is randomized to reduce swings in neural network weight updates from a segment of similar date in the same epoch. This smooths out the overall optimization process to enable better long-term optimization.

The data training and test data is exported (1412) into the format needed for model training.

FIG. 15A Pure Audio Sound: In case of audio events, a challenge for machine learning models is to address the background noise. For example, in case of cough detection, there are different scenarios like hospital, office, school etc which will have varying levels of background noise or chatter. The saved positive event in this case is pure sounds that are free of background noise. This Pure Audio Sound can be updated by FogHorn as required. For example, in cavitation, we can update the sound files based on pump capacity and manufacturer in accordance with the site where it is deployed or when a customer upgrades or changes his equipment. In various implementations, a pure event or example (e.g., pure audio and/or video sound/image/event/etc.) could include examples that are entirely free of background or other extraneous audio and/or visual noise and/or could include examples that include less than a threshold amount of noise (e.g., less than a certain percentage or amount of noise).

FIG. 15B: The background sound would be normal sounds in the operating environment at the deployment site, such as at the hospital, office, school, manufacturing, refinery or other places. The background sounds will vary by time of day and many other conditions.

FIG. 15C shows the result of the Software Augmenter to combine a provided (by the app) cough sound with a local site background. This can be done with a standard software process like an audio mixer, to create a simulation of the actual cough in the local background.

FIG. 15D is to compare the simulated Cough in the local background against an actual cough. The similarity is a validation of the process.

FIG. 15E shows an example of provided positive examples that can be shipped with the application. For a Worker Safety application, this includes examples of workers wearing a vest (safe), not wearing helmets (alert), wearing a mask (safe), not wearing a mask (alert). The colors of the helmet are not relevant to the patent, just an example of variation that may normally occur in a given application. Note the terms “alert” versus “safe” in this example sound positive and negative—but that is specific to the vertical application, not to the patent. In terms of the data flow, these are all “positive” conditions that the neural net or machine learning model needs to learn to recognize. In contrast “negative” image sections would be confusion cases in the environment, which could be confused with what needs to be recognized by the application system.

FIG. 15F shows a visual local background. For the Worker Safety application, this can be a current construction site, although it could be other industrial settings. This image does not have other people.

FIG. 15G shows the combined visual subjects of interest on local background.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

What is claimed is:

1. A method for automatically detecting events, the method comprising:
receiving a signal from one or more audio and/or visual devices in a deployed environment;
running a preprocessing script for buffering the signal to a particular length to feed into a machine learning model;
processing the buffered signal using the machine learning model to identify one or more negative examples;
mixing the negative examples with a saved pure example to create one or more positive examples; and
using the created one or more positive examples and one or more negative examples to retrain the machine learning model at an edge device without the need for human annotation.

2. The method of claim 1, wherein the audio or visual device includes at least one of a microphone, a video device, and an infra-red or distance sensor.

3. The method of claim 2, further comprising bundling the machine learning model with scripts for at least one of an inference event, a training event, a pure audio event, a video event, or an infra-red or distance sensor event.

4. The method of claim 3, wherein the preprocessing script acts as a sensor to buffer the signal received from the microphone.

5. The method of claim 3, wherein running the signal into the machine learning model to identify negative examples comprises:
calling, by at least one of the scripts, the machine learning model at initialization;
extracting a spectrogram from the signal;
providing a labeled positive and negative output; and
saving the negative example on the edge device.

6. The method of claim 3 wherein the mixing the negative examples with the saved pure example to create positive examples comprises:
receiving a trigger event that precedes retraining the machine learning model;
mixing the saved pure examples of supported types stored in the edge device with the negative examples from an environment to create positive examples; and
storing the positive examples in the edge device.

7. The method of claim 3, further comprising: calling, based on a trigger event, for re-training the machine learning model that is stored in the edge device;
re-training the machine learning model on the created positive example and saved negative signals;
bundling up the machine learning model to create a new edge machine learning version; and
replacing the current version of edge machine learning with the new edge machine learning version.

8. The method of claim 1, further comprising optimizing at least one of a software component or a hardware component executing the machine learning model.

9. The method of claim 1, wherein retraining the machine learning model further comprises automatically detecting a trigger event for re-training a machine learning model, wherein automatically detecting the trigger event comprises:
receiving a distribution of training data;
creating a distribution of current data based on the distribution of training data;
compare the difference between the distribution of training data and the distribution of current data; and
in response to the difference being above a first threshold, detect the trigger event for re-training the machine learning model.

10. The method of claim 9, wherein comparing the differences between the distribution of training data and the distribution of current data comprises measuring a Kullback-Leibler divergence between the distribution of training data and the distribution of current data.

11. The method of claim 9, wherein comparing the differences between the distribution of training data and the distribution of current data comprises measuring the difference in accuracy between the distribution of training data and the distribution of current data.

12. The method of claim 9, further comprising re-training the machine learning model using close loop learning in response to detecting the trigger event.

13. A system comprising:
an audio or visual device; and
a computing system comprising one or more processors and a memory, the memory having instructions stored thereon that, when executed by the one or more processors, cause the one or more processors to:
receive a signal from the audio or visual device in a deployed environment;
run a preprocessing script for buffering the signal to a particular length to feed into a machine learning model;
run the signal into the machine learning model to identify one or more negative examples;
mix the negative examples with a saved pure example to create one or more positive examples; and
use the created one or more positive examples and one or more negative examples to retrain the machine learning model at an edge device without the need for human annotation.

14. The system of claim 13, wherein the audio or visual device includes at least one of a microphone, a video device, or an infra-red or distance sensor.

15. The system of claim 14, wherein the instructions further cause the one or more processors to bundle the machine learning model with scripts for at least one of an inference event, a training event, a pure audio event, a video event, or an infra-red or distance sensor event.

16. The system of claim 14, wherein the preprocessing script acts as a sensor to buffer the signal received from the microphone.

17. The system of claim 15, wherein running the signal into the machine learning model to identify negative examples comprises:
calling, by at least one of the scripts, the machine learning model at initialization;
extracting a spectrogram from the sound signal;
providing a labeled positive and negative output; and
saving the negative example on the edge device.

18. The system of claim 14, wherein the mixing the negative examples with the saved pure example to create positive examples comprises:
receiving a trigger event that precedes retraining the machine learning model;
mixing the saved pure examples of supported types stored in the edge device with the negative examples from an environment to create positive examples; and
storing the positive examples in the edge device.

19. The system of claim 14, wherein the instructions further cause the one or more processors to:
call, based on a trigger event, for re-training the machine learning model that is stored in the edge device;
re-train the machine learning model on the created positive example and saved negative examples;
bundle up the machine learning model to create a new edge machine learning version; and
replace the current version of edge machine learning with the new edge machine learning version.

20. The system of claim 13, wherein the instructions further cause the one or more processors to optimize at least one of a software component or a hardware component executing the machine learning model.
